(19) United States
(12) Patent Application Publication
(10) Pub. No.: US 2004/0164561 A1
(43) Pub. Date: Aug. 26, 2004

(54) Drive power apparatus and rotating member utilizing wind and blade member thereof

(76) Inventors: Masato Nagawa, Fukuoka (JP); Hideki Noda, Fukuoka (JP); Kinjiro Saitoh, Fukuoka (JP)

Correspondence Address: STRAUB & POKOTYLO, 620 TINTON AVENUE, BLDG. B, 2ND FLOOR, TINTON FALLS, NJ, 07724, US

(21) Appl. No.: 10/717,241

(22) Filed: Nov. 19, 2003

(30) Foreign Application Priority Data
Feb. 21, 2003 (JP) 044768/2003
Jun. 20, 2003 (JP) 176985/2003
Jul. 30, 2003 (JP) 282523/2003

(51) Int. Cl. F03D 9/00

(52) U.S. Cl. 290/55

(57) ABSTRACT

A drive power apparatus utilizing winds is disclosed. A vertical shaft 12 disposed vertically and rotatably, a rotatable horizontal shaft 16-18 rotatably perpendicularly penetrating the vertical shaft 12, a first and a second plate-like blade members 19 to 24 provided on the horizontal shaft 16 to 18 on the opposite sides of the vertical shaft 12 and a drive power mechanism 21 operable with the rotation of the vertical shaft 12 are provided. The first and second blade members 19 to 24 are secured to the horizontal shaft 12 such that their plane orientations are deviated from each other by an angle of 90 degrees in the peripheral direction of the horizontal shaft 12, and are rocked about the horizontal shaft 12 in an interlocked relation to each other between the vertical and horizontal directions.

### BACKGROUND OF THE INVENTION

This application claims benefit of Japanese Patent Applications No. 2003-044768 and filed on Feb. 21, 2003, No. 2003-176985 and filed on Jun. 20, 2003, and No. 2003-282523 filed on Jul. 30, 2003, respectively, the contents of which are incorporated by the reference.

The present invention relates to drive power apparatuses and rotating member utilizing winds and operable by obtaining drive power therefrom, and also to blade members used in these drive power apparatuses.

Among drive force apparatuses utilizing winds are those which include electric power generator for generating electric power and those which include pumps for withdrawing water.

These drive power apparatuses have various constructions. Among these drive apparatuses is one, which comprises a vertical shaft capable of being rotated (hereinafter referred to as vertical shaft), horizontal shafts perpendicularly mounted on the vertical shaft, and blade members (or wings) mounted on the horizontal shafts, the blade members being operable to receive winds and thereby rotate the vertical shaft via the horizontal shaft. Such a drive power apparatus is disclosed in, for instance, Literatures 1 (Japanese patent laid-open Shou 53-13040, Literatures 2 (Japanese patent laid-open Hei 3-202679, and Literatures 3 (Japanese patent laid-open 2002-21706.

Drive power apparatuses utilizing winds are preferably rotated smoothly even by slight winds, for instance those with wind velocities of 3.4 m/sec. called “wind power 2”. To this end, it is utmost important how to convert the wind energy to the rotational drive power of the vertical shaft efficiently, i.e., by preventing the wind energy loss as much as possible.

However, the construction in the prior art is complicated and tends to be heavy in weight. Besides, the prior art has a considerable number of causes of loosing wind energy. Therefore, in the prior art it has been difficult to smoothly rotate the vertical shaft.

For example, the Literature 1 discloses a drive power apparatus, which comprises a vertical shaft (i.e., wheel shaft in the Literature 1), horizontal shafts (i.e., blade mounting shafts), blade members (i.e., blade) and members for suppressing the rotation of the blade members (i.e., suppressing bars).

Such a drive power apparatus disclosed in the Literature 1 has the following causes of great wind energy loss.

With an orientation change of each blade member from a direction fully irrelevant to receiving wind power (i.e., horizontal direction and hereinafter referred to as irrelevant direction) to a direction of fully receiving wind power (i.e., vertical direction and hereinafter referred to as receiving direction), each blade member is operated independently of the other blade member or members and is thus moved suddenly to collide with the associated suppressing bar. At this time, vibrations are generated. The vibrations thus generated have adverse effects on the operation of the individual blade members and other members and interferes with the smooth operation of these members, thus resulting in great loss of wind energy.

Also, an orientation change of each blade member from the receiving direction (i.e., vertical direction) to the irrelevant direction (i.e., horizontal direction), the individual blade members operate slowly because they only follow the flow of wind. Furthermore, since the individual blade members are pulled downward by their gravitational forces, then cannot be fully raised to be horizontal when the wind power is weak. In these cases, the blade members act as brakes.

Furthermore, in the apparatus disclosed in the Literature 1, the number of blade members disposed on the same horizontal plane are not prescribed, but shows a plurality of (i.e., four) blade members disposed on the same horizontal plane. With such a structure, some blade members may come to leeward of other blade members, and the leeward blade members do not receive any wind power. Again in this case, the leeward blade members act as brakes.

Still further, since the vertical shaft supports the horizontal shafts in a so-called cantilever fashion, horizontal shaft support mechanisms of the vertical shaft should be mechanically strong. For this reason, weight or thickness increase of the mechanism is dictated, which is undesired for smooth rotation of the blade members.

Literature 2 discloses a drive power apparatus, which comprises a vertical shaft (i.e., vertical shaft in Literature 2), horizontal shafts (i.e., lateral bars), blade members (i.e., rotational blades), mechanisms for rotating the blade members by a predetermined angle with rotation of the vertical shaft (angle converter parts), and members (or blades) for operating the mechanisms. Literature 3, like the Literature 2, discloses a drive power apparatus, which comprises a vertical shaft (i.e., rotational shaft in Literature 3), horizontal shafts (i.e., core rods), blade members (i.e., wind-receiving wings), mechanisms for rotating the blade members by a predetermined angle with rotation of the vertical shaft (i.e., wind operating rods, levers, chain, lever securing frames, rotational boards, etc.), and members (i.e., direction rudders) for operating the mechanisms.

In the drive power apparatus disclosed in the Literatures 2 and 3, wind energy is greatly lost by the following cause.

In the apparatus disclosed in the Literatures 2 and 3, the direction in which winds can be suitably received, is limited, and for obtaining the best efficiency complicated mechanisms, that is, members for operating mechanisms (i.e., blades shown in the Literature 2, direction rudders in the Literature 3 and mechanisms rotatably supporting mechanisms). Therefore, a wind direction change results in failure of smooth operation of the blade members and other members of the apparatus, thus transiently reducing the efficiency. In addition, a certain time is required until the best efficiency is obtained. Furthermore, the apparatus has a number of members receiving the wind resistance other than the blade members. Still further, since the construction is complicated, the weight of the mechanism is increased.

Moreover, in the apparatuses disclosed in the Literatures 2 and 3 the number of blade members disposed on the same horizontal plane is not prescribed, but shows a number of (i.e., four) blade members disposed in the same horizontal plane. In such an arrangement, however, some blade members may be leeward of other blade members, and the leeward blade members do not receive any wind power. Again in this case, the leeward blade members act as brakes.

The above causes impede smooth rotation of the blade members, resulting in great wind energy loss.

As shown above, the apparatuses disclosed in the Literatures 1 to 3 has causes of wind energy loss, and with slight winds the vertical shaft is not rotated or undergoes awkward rotation, if any. In other words, the apparatuses disclosed in the Literatures 1 to 3 have a problem that with slight winds it is difficult to cause smooth rotation of the vertical shaft.

Aside from the above problem, the apparatus disclosed in the Literature 1 also has a secondary problem that by the collision of the blade members and the suppressing bars such noise as “bang, bang, . . . ” is generated. The apparatuses disclosed in the Literatures 2 and 3 have further problems that it has a number of components, leads to high cost of manufacture due to the complicated construction, can not be easily installed and is readily liable to trouble occurrence.

### SUMMARY OF THE INVENTION

The present invention has been made in view of the above background affairs, and it has an object of providing a drive power apparatus and rotating member utilizing winds, which permits weight reduction and also permits rotation of a vertical shaft even with slight winds, and a blade member suitable for use in the same drive power apparatus.

According to an aspect of the present invention, there is provided a drive power apparatus and rotating member utilizing winds comprising: a vertical shaft disposed vertically and rotatably; a rotatable horizontal shaft rotatably perpendicularly penetrating the vertical shaft; a first and a second plate-like blade member provided on the horizontal shaft on the opposite sides of the vertical shaft; and a drive power mechanism operable with the rotation of the vertical shaft; wherein the first and second blade members are secured to the horizontal shaft such that their plane orientations are deviated from each other by an angle of 90 degrees in the peripheral direction of the horizontal shaft, and are rocked about the horizontal shaft in an interlocked relation to each other between the vertical and horizontal directions.

The first and second blade members of such drive power apparatus operate as follows. At the time of no load and no wind, the first and second blade members remain stationary with their plane orientations at a downward angle of 45 degrees from horizontal plane. When the drive power apparatus in the state receives wind, either the first or the second blade members function to receive torque generated by wind (hereinafter referred to as power of wind. At this time, the plane orientation of either the first or the second blade members are in a direction to receive wind (i.e., horizontal direction, in which the resistance against wind is maximum), and the plane orientation of the other blade members are in a direction to pass wind (i.e., horizontal direction, in which the resistance against wind is minimum). The first-mentioned blade members, receiving the power of wind, pushes the horizontal shafts in a predetermined direction, and the horizontal shafts rotate the vertical shaft. Subsequently, the plane orientation of the first-mentioned blade members undergoes a gradual transition from the direction to receive wind (i.e., vertical direction) to the direction to pass wind (i.e., horizontal direction), and in an interlocked relation to this transition of the plane orientation of the other blade members undergoes a transition from the direction to pass wind (i.e., horizontal direction) to the direction to receive wind (i.e., vertical direction). When the other blade members eventually come to receive wind, this time the other blade members function to raise the first-mentioned blade members in the horizontal direction, while pushes the horizontal shafts in a predetermined direction by receiving the power of wind, thus rotating the vertical shaft. Subsequently, the plane orientation of the other blade members undergoes a gradual transition from the direction to receive wind (i.e., vertical direction) to the direction to pass wind (i.e., horizontal direction), and in an interlocked relation to this transition the plane orientation of the first-mentioned blade members undergoes a transition from the direction to pass wind (i.e., horizontal direction) to the direction to receive wind (i.e., vertical direction). When the first-mentioned blade members eventually come to receive wind, this time the first-mentioned blade members raise the other blade members in the horizontal direction, while pushing the horizontal shafts in a predetermined direction by receiving the power of wind, thus rotating the vertical shaft. Subsequently, the first and second blade members alternately repeat like operations to rotate the vertical shaft. These first and second blade members operate in an interlocked relation to one another (i.e., operate by utilizing the power of wind acting on the mutual blade members). The operation is thus subjected to loss of low energy and very smooth. Such operation of the first and second blade members is realized by the horizontal shafts penetrating the vertical shaft.

In the drive power apparatus utilizing winds according to the present invention, the first and second blade members are operated in an interlocked relation to one another by the horizontal shafts. Thus, since either one of the first and second blade members act to raise the other blade members in the horizontal direction in the plane orientation change from the direction to pass wind to the direction to receive wind. Thus, the blade members are restricted in operation and are not suddenly operated. Conversely, in the plane orientation change in either one of the first and second blade members, the other blade members are raised in the horizontal direction, and thus can attain the horizontal state in a quick operation. Also, even when either one of the first and second blade members are in the direction to pass wind, they are held in the horizontal direction by the other blade members, so that they are not moved pit-a-pat. As shown, the first and second blade members operate such as to make up for the movement of one another, so that their operation is very smooth. Thus, the drive power apparatus utilizing winds according to the present invention can convert wind energy to the rotation driven power of the vertical shaft very efficiently, i.e., without substantial wind energy loss. This means that the vertical shaft can be rotated even with sight winds. Also, it is possible to suppress generation of vibrations and noise.

The drive power apparatus utilizing winds according to the present invention is formed by merely arranging such that the vertical shaft is penetrated by the horizontal shafts and that the first and second blade are secured to each horizontal shaft on the opposite sides thereof in a phase difference of 90 degrees. Thus, neither any complicated mechanism for operating the blade members in a supported state thereof nor any complicated mechanism for rotating the horizontal shafts is necessary. The apparatus thus can be constructed with a minimum number of component parts. It is thus possible to simplify and reduce weight of the construction. Also, it is possible to reduce the cost of manufacture, permit ready installation of the apparatus and ensures less occurrence troubles.

In the drive power apparatus utilizing winds, the first and second blade members are preferably arranged as follows. Denoting the two parts of each of the first and second blade members defined by the associated horizontal shaft by a first and a second section, the first and second blade members of the first and second blade members are preferably formed such that they receive power of different magnitudes from wind, and they are also preferably provided with a weight balance arrangement of providing a load on the lower one of the rotation momentums generated on the first and second blade members by gravitational force. Ideally, the first and second blade members are preferably formed, by the weight balance adjustment, that the difference between the rotational momentums generated on the first and second blade members by gravitational force is at most below 0.2 times the higher one of the rotational momentums generated on the first and second blade members by gravitational force. With the first and second blade members thus weight balance adjusted such that the rotation momentum is approximately zero, energy loss is little, and very smooth rotation is obtainable even with slight winds.

In the drive power apparatus utilizing winds, the horizontal shafts are preferably disposed as respective stages on the vertical shaft at different vertical positions thereof and at a circumferential deviation by a predetermined angular interval from each other. Particularly, the predetermined angular interval is preferably an angle as a division of 180 degrees by the number of stages or an integral multiple of this value. The first and second blade members as a plurality of stages disposed one above another on the vertical shaft they are each at a predetermined angular deviation from one another. The first and second blade members are provided in a plurality of stages (specifically 3 to 20 stages or more) at an interval from one another with respect to the vertical shaft. Besides, in the top view the first and second blade members are radially uniformly disposed about the vertical shaft. With this arrangement, some of the first and second blade members always receive wind power, while no other blade members that may otherwise constitute brakes are present in the same horizontal plane, thus permitting smooth operation. Thus, the drive power apparatus permit obtaining drive power free from rotation torque fluctuations with respect to the rotation shaft and realizing high efficiency. The horizontal shafts each constituting a stage of a first and a second blade member, are ideally disposed in a helical fashion. Thus, wind power is always received by either one of the blade members, and no other blade member constituting a brake is found on the same horizontal plane. Furthermore, since the stages receiving wind are displaced upward or downward, it is possible to dispense power applied to the vertical shaft and thus reduce vibrations. Thus, it is possible to permit further smooth operation of the first and second blade members. The drive power apparatus thus can obtain drive power free from rotation torque fluctuations with respect to the vertical shaft and realize high efficiency.

The drive power apparatus utilizing winds according to the present invention has restricting mechanisms for restricting the rotation of the horizontal shafts to a range of 90 degrees. The restricting mechanisms are each preferably constituted by a first and a second contact member provided on the opposite sides of the horizontal shaft with respect to the vertical shaft, and a first and a second contactable member provided on the vertical shaft and capable of being contacted by the first and second contact members, respectively.

Furthermore, in the drive power apparatus utilizing winds according to the present invention, the first and second blade members preferably include shock absorbers. With this arrangement, the drive power apparatus can alleviate shocks exerted to the first and second blade members, the horizontal shafts and the vertical shaft, thus preventing wear of these members and extending the life of the whole apparatus.

Further, the drive power apparatus utilizing winds according to the present invention preferably include stoppers, which are projecting from the vertical shaft and stopping the rotation of the first and second blade members in contact with these members. In this way, the drive power apparatus can stop the opposite side blade members at adequate angles. The blade members can be stopped with power less than that for stopping the horizontal shafts themselves.

Further, in the drive power apparatus utilizing winds according to the present invention, the vertical shaft preferably has a bearing for alleviating frictional resistance offered to the horizontal shafts. Owing to these bearings, the horizontal shafts can be rotated with less frictional resistance and, in this state, rotate the vertical shaft.

Further, the drive power apparatus utilizing winds according to the present invention preferably has rotation setting mechanisms for setting the direction of rotation of the vertical shaft. Particularly, the rotation setting mechanisms each preferably include a protuberance provided in each horizontal shaft and an engagement member provided on each of the first and second blade members for determining, in engagement with the protuberance, the direction of rotation of the vertical shaft. The engagement member is, for instance, a pin which is inserted in a hole formed in the outer periphery of each horizontal shaft supporting the first and second blade members. Two holes for engagement are formed on the opposite sides of the protuberance, and the pin is inserted in either one of these holes in dependence on the direction of rotation of the vertical shaft. With this arrangement, the drive power apparatus can set the direction or rotation of the vertical shaft as desired.

Further, the drive power apparatus utilizing winds according to the present invention preferably include oil hydraulic bumpers, which are provided on the horizontal shafts for setting the plane orientations of the first and second blade members. Thus, the drive power apparatus permits securing the first and second blade members in desired plane orientations and alleviating shocks exerted to the first and second blade members.

Further, the plate-like blade members of the drive power apparatus utilizing winds according to the present invention are preferably formed such that, denoting the two parts of each blade member as defined by each horizontal shaft by a first and a second section, the first and second sections receive power of different magnitudes from wind, while they has been provided with weight balance adjustment of providing a load to the lower one of the rotation momentums generated on the first and second blade members by gravitational force. Ideally, the blade members are formed, by the weight balance adjustment, such that the difference between the rotation momentums generated on the first and second sections by gravitational forces is at most 0.2 times the higher rotation momentum. Since these blade members have been weight balance adjusted such that the rotation momentum is approximately zero, energy is less lost, and the operation is very smooth.

The rotation momentum difference is preferably set such that the first and second sections are different in weight per unit area-, and the weights per unit area of the first and second sections are preferably made different by either one of the following ways. That is, the weights per unit area of the first and second blade members are made different by providing a load to either one of the first and second blade members. Alternatively, the weights of the first and second sections are preferably made different by forming these members from materials of different specific gravities. As a further alternative, the weights per unit area of the first and second sections are preferably made different by setting different thickness of these members. In either of these cases, at the time of no load and no wind, the first and second blade members can be stopped in a predetermined stable state (i.e., a state with the plane orientations at a downward angle of 45 degrees from horizontal plane), and can also be smoothly operated at the time of start of rotation and during the rotation.

Further, for reducing the inertial momentum which is increased when reducing the difference of the rotation momentums generated on the first and second sections by gravitational forces, the load provided for reducing the rotation momentum difference is ideally located at a position within 0.1 times the width of the load provision side section from the horizontal shaft.

Further, the blade members preferably have auxiliary wings extending in a direction perpendicular to the horizontal shafts. The auxiliary wings serve to push winds tending to get out from the outer end of the first and second blade members. With this arrangement, the drive power apparatus permits improving the wind power applied to the first and second blade members by about several to several ten percent, thus improving the efficiency of conversion of wind energy to drive power.

Further, the blade members preferably have grooves formed in their surfaces. These grooves function to seal wind. Thus, the drive power apparatus permits improving the wind power applied to the first and second blade members by about several to several ten percent, thus improving the efficiency of conversion of wind energy to drive power.

According to the present invention, the following effects are obtainable.

In the drive power apparatus utilizing winds according to the present invention, the horizontal shafts rotatably penetrating the vertical shaft permit the first and second blade members to be rocked about the horizontal shafts in an interlocked relation to one another between the vertical and horizontal directions.

Such a drive power apparatus can be operated very smoothly because the blade members operate such as to mutually make up for their movements. Besides, no blade member or other member acting as brake is present. Thus, the drive power apparatus utilizing winds according to the present invention is very efficient, and can convert wind energy to rotation drive power of the vertical shaft without substantial wind energy loss. Thus, the vertical shaft can be rotated even with slight winds. Also, it is possible to suppress vibrations and noise generation. Furthermore, the apparatus can be constructed with a least number of components. Thus, it is possible to simplify and reduce weight of the construction and also reduce the cost of manufacture. Also, the apparatus can be readily installed, and it is possible to reduce the possibility of trouble occurrence.

Also, in the drive power apparatus utilizing winds according to the present invention, the first and second blade members are preferably formed such that the first and second sections receive wind power of different magnitudes and also that they are formed by being provided with a weight balance adjustment of providing a load to the lower one of the rotation momentums generated on them by gravitational forces. Ideally, the first and second blade members are preferably formed such that the difference between the rotation momentums generated on the first and second sections by gravitational forces is no higher than 0.2 times the higher rotation momentum. Since such first and second blade members are weight balance adjusted such that the rotation momentum approximates zero, energy is less lost, and the very smooth rotation is obtainable even with slight winds.

Furthermore, in the drive power apparatus utilizing winds according to the present invention the horizontal shafts are preferably disposed as respective stages on the vertical shaft at different vertical positions thereof and in a predetermined angle interval deviation about the vertical shaft from one another. With this arrangement, wind is always received by some of the first and second blade members. Also, since no other blade member constituting a brake is present on the same horizontal plane, smooth operation is obtainable. Thus, the drive power apparatus permits obtaining drive power, which is free from rotation torque fluctuations with respect to the vertical shaft, and also permits realizing high efficiency. The first and second horizontal shafts as respective stages with the first and second blade members, are ideally disposed helically. This arrangement permits ready weight balance and angle adjustments of the first and second blade members at the time of the installation of the apparatus.

Further, the drive power apparatus utilizing winds according to the present invention preferably have restricting mechanisms for restricting the rotation of the horizontal shafts to a range of 90 degrees. This arrangement permits that the drive power apparatus reliably secures the rotation angle range of the horizontal shafts.

Further, the drive power apparatus utilizing winds according to the present invention preferably have shock absorbers provided on the first and second blade members. The arrangement permits that the drive power apparatus alleviates shocks exerted to the first and second blade members, the horizontal shafts and the vertical shaft, and prevent wear of these members and extend the life of the whole apparatus.

Further, the drive power apparatus utilizing winds according to the present invention preferably have stoppers, which project from the vertical shafts and adapted to be in contact with the first and second blade members to stop the rotation thereof. Thus, in the drive power apparatus the opposite side blade members can be stopped at a proper angle. Besides, stopping the blade members requires less power than stopping the horizontal shafts.

Further, in the drive power apparatus utilizing winds according to the present invention, the vertical shaft preferably has bearings for alleviating frictional resistance offered to the horizontal shafts. Owing to these bearings, the horizontal shafts can be rotated with less frictional resistances and, in the state, rotate the vertical shaft.

Further, the drive power apparatus utilizing winds according to the present invention preferably has a rotation setting mechanism for setting the direction of rotation of the vertical shaft. It is thus possible to set the direction of rotation of the vertical shaft of the drive power apparatus as desired.

Further, the drive power apparatus utilizing winds according to the present invention preferably have oil hydraulic bumpers, which are provided on the horizontal shafts for setting the plane orientation of the first and second blade members. It is thus possible to secure the first and second blade members in desired plane orientations and also alleviate shocks applied to the first and second blade members.

Further, the drive power apparatus utilizing winds according to the present invention is preferably formed such that the first and second sections receive wind power of different magnitudes and also formed by being provided with a weight balance adjustment of providing a load for the lower one of the rotation momentums generated on the first and second sections by gravitation forces. Ideally, the first and second blade members are formed by weight balance adjustment such that the difference between the rotation momentums generated on the first and second sections by gravitational forces is at most no higher than 0.2 times the higher one of the rotation momentums generated on the first and second sections by gravitational forces. Since the blade members are weight balance adjusted such that the rotation momentum approximates zero, energy is less lost, and very smooth rotation is obtainable even with slight winds.

The rotation momentum difference of the blade members is preferably set by making the weights per unit area of the first and second sections different, and also the weights per unit area of the first and second sections different by either one of the following ways. That is, the weights per unit area of the first and second sections are made different by disposing a load in either one of the first and second sections. Alternatively, the weights per unit areas of the first and second sections are made different by forming the first and second sections from material having different specific gravities. As a further alternative, the weights per unit area of the first and second sections are made different by setting different thickness of the first and second sections. In either of the above cases, the first and second blade members become stationary, at the time of no load and no wind, in a predetermined stable state (i.e., with their plane orientations at a downward angle of 45 degrees from horizontal plane, and their smooth operation is obtainable at the time of start of rotation and during rotation.

Further, in order to reduce the inertial momentum, which is increased when reducing the difference between the rotational momentums generated on the first and second sections by gravitational forces, the blade members are ideally formed by setting the position of the load provided for the rotational momentum difference reduction to be within 0.1 times the width of the load provision side member from the horizontal shafts. By so doing, the blade members can be rotated very smoothly even with slight winds.

Further, the blade members preferably have auxiliary winds extending in a direction perpendicular to the horizontal shafts. The auxiliary wings function to press wind tending to get out of the first and second blade members from the outer end thereof. In this way, it is possible to improve the wind power exerted to the first and second blade members of the drive power apparatus by several to several ten percent and improve the efficiency of conversion of wind energy to drive power.

Further, the blade members preferably have grooves formed in their plane. These grooves function to seal wind. Thus, it is possible to improve the wind power exerted to the first and second blade members of the drive power apparatus to several to several ten percent, thus improving the efficiency of conversion of wind energy to drive power.

According to other aspect of the present invention, there is provided a rotating member utilizing winds comprising: a vertical shaft disposed vertically and rotatably; a rotatable horizontal shaft rotatably perpendicularly penetrating the vertical shaft; and a first and a second plate-like blade member provided on the horizontal shaft on the opposite sides of the vertical shaft; wherein the first and second blade members are secured to the horizontal shaft such that their plane orientations are deviated from each other by an angle of 90 degrees in the peripheral direction of the horizontal shaft, and are rocked about the horizontal shaft in an interlocked relation to each other between the vertical and horizontal directions.

Denoting two parts of each of the first and second sections as defined by the horizontal shaft to be a first and a second section, respectively, the first and second sections are formed such as to receive wind power of different magnitudes and provided by a weight balance adjustment of providing a load on the side of the lower one of the rotation momentums generated on the first and second sections by gravitational forces.

The first and second blade members are formed by the weight balance adjustment such that the difference between the rotation momentums generated on the first and second sections by gravitational forces is at most no higher than 0.2 times the higher one of the rotation momentums generated on the first and second sections by gravitational forces. A plurality of horizontal shafts are disposed as respective stages on the vertical shaft at vertically different positions thereof and in a predetermined angular interval deviation from one another in the peripheral direction of the vertical shaft. The predetermined angle is obtained by dividing 180 degrees by the number of stages or a multiple of that angle. The horizontal shafts constituting the respective stages are disposed helically. The rotating member further comprises a restricting mechanism for restricting the rotation of each horizontal shaft to a range of 90 degrees, and in which the restricting mechanism includes a first and a second contact member provided on the horizontal shaft on the opposite sides of the vertical shaft, and a first and a second contactable member provided on the vertical shaft and capable of being contacted by the first and second contact members. The first and second blade members are provided with shock absorbers. The rotating member further comprises: stoppers projecting from the vertical shaft for stopping the rotation of the first and second blade members in contact with the first and second blade members. Vertical shaft has bearings for alleviating frictional resistance with respect to each horizontal shaft. The rotating member further comprises a rotation setting mechanism for setting the direction of rotation of the vertical shaft. The rotation setting mechanism includes a protuberance provided on each horizontal shaft and an engagement member for determining the direction of rotation of the vertical shaft in engagement with the protuberance. The rotating member further comprises oil hydraulic bumpers provided on each horizontal shaft for setting the plate orientations of the first and second blade members.

Other objects and features will be clarified from the following description with reference to attached drawings.

### BRIEF DESCRIPTION OF THE DRAWINGS

FIG. 1 is a front view showing an embodiment of the drive power apparatus utilizing winds according to the present invention;

FIG. 2 shows a plan view of drive power apparatus utilizing winds according to the present invention;

FIGS. 3(a) and 3(b) show the output characteristics of either ones of the first and second blade members 19 to 24;

FIG. 4 is an enlarged-scale front view showing a part P in FIG. 1;

FIG. 5 is an enlarged-scale side view showing the part P in FIG. 1;

FIG. 6 shows the structure of the blade member 19;

FIGS. 7 and 8 show the stems (i.e., ends) of the horizontal shafts;

FIGS. 9(a) to 9(c) are views showing the operation of the blade members;

FIGS. 10(a) to 10(c) are views showing the operation of the blade members;

FIGS. 11 and 12 show the position of support point;

FIGS. 13(a) and 13(b) are views showing the action of gravitational force;

FIGS. 14(a) to 14(c) are views showing this way of weight balance adjustment;

FIG. 15 is a view showing the inertial momentum applied to the blade member;

FIG. 16 is a view showing the relation between the position of disposition of the load member and the inertial momentum;

FIGS. 17(a) and 17(b) a reviews showing a way of weight balance adjustment;

FIG. 18 shows a shape of the blade member;

FIG. 19 is a view showing a first modification of the drive power apparatus utilizing winds;

FIG. 20 is a view showing a second modification of the drive power apparatus utilizing winds;

FIG. 21 is a view showing a third modification of the drive power apparatus utilizing winds;

FIGS. 22 and 23 are views showing a fourth modification of the drive power apparatus utilizing winds;

FIG. 24 shows an enlarged-scale view of S in FIGS. 22 and 23;

FIG. 25 is a view showing a fifth modification of the drive power apparatus utilizing winds; and

FIG. 26 is a view showing a sixth modification of the drive power apparatus utilizing winds.

### PREFERRED EMBODIMENTS OF THE INVENTION

Preferred embodiments of the present invention will now be described with reference to the drawings. The Figures merely roughly illustrate the present invention such that the present invention can be understood. The present invention is thus by no means limited to the illustrated embodiment. In the Figures, common elements and like elements are designated by like reference numerals, and are not described again.

(Embodiment 1)

A first embodiment of the present invention will now be described with reference to the drawings.

(Overall Construction of the Drive Power Apparatus Utilizing Winds)

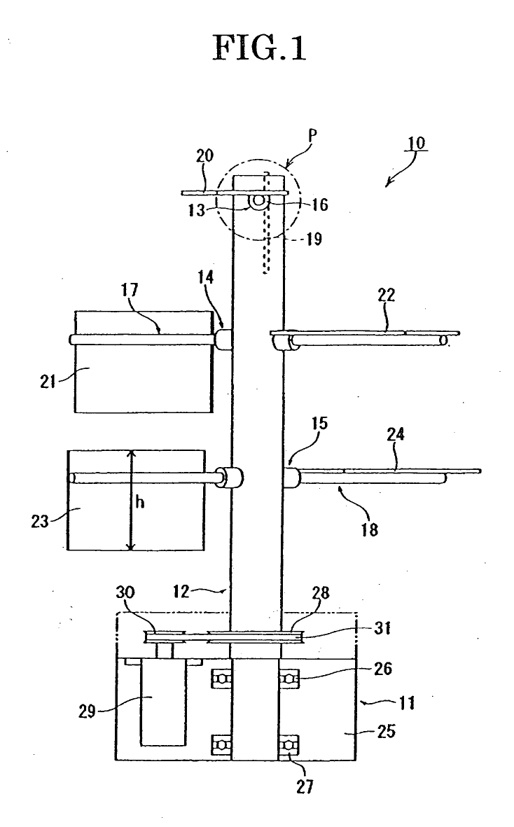

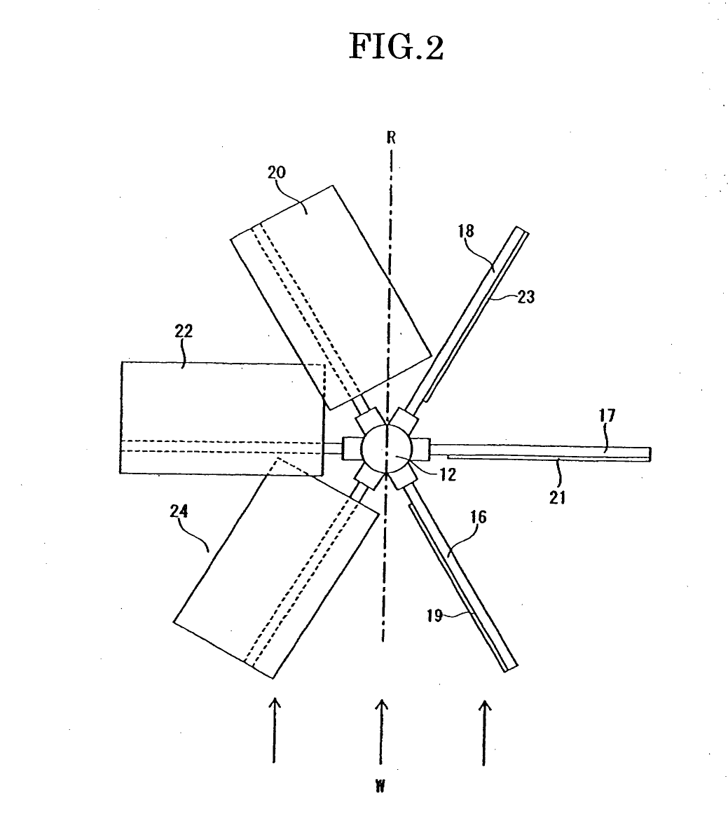

FIGS. 1 and 2 are a front view and a plan view showing an embodiment of the drive power apparatus utilizing winds according to the present invention.

As shown in FIG. 1, the embodiment of the drive power apparatus 10 utilizing winds according to the present invention comprises a vertically rotatably disposed vertical shaft 12, horizontal shafts 16 to 18 disposed on the vertical shaft 12 in a vertically spaced-apart relation to one another and penetrating the vertical shaft 12, plate-like first and second blade members 19 to 24 mounted on the horizontal shafts 16 to 18 on the opposite sides of the vertical shaft 12, and an electric power generator 29 as drive power mechanism operable with the rotation of the vertical shaft 12.

The first and second blade members 19 to 24 are secured to the horizontal shafts 16 to 18 such that their plane orientations are deviated by an angle of 90 degrees from one another around the horizontal shafts 16 to 18. At the time of no load and no wind, the first and second blade members 19 to 24 are held stationary such that their plane orientations are at a downward angle of 45 degrees from horizontal plane. When the first and second blade members 19 to 24 receive winds, they are rocked in an interlocked relation to one another about the horizontal shafts 16 and 18 between the vertical and the horizontal direction.

In the FIG. 1 arrangement, the vertical shaft 12 has its lower end part mounted in a base 11, but this position of mounting of the vertical shaft 12 is by no means limitative. For example, the vertical shaft 12 has its upper end parts or both upper and lower ends mounted in the base 11.

In the FIG. 1 arrangement, bearing parts 13 to 15 are provided between the vertical shaft 12 and the horizontal shafts 16 to 18, respectively. This arrangement has an effect of reducing the frictional resistance between the vertical shaft 12 and the horizontal shafts 16 to 18.

While in the FIG. 1 arrangement three pairs of first and second blade members are disposed one above another in three stages, this number of pairs of first and second blade members is by no means limitative; for example, it is possible to dispose only a single pair or a plurality of pairs including three pairs. As for the number of pairs of first and second blade members, however, the efficiency is superior with a plurality of pairs to the case of a single pair, as will be described later in details.

With a plurality of pairs of first and second blade members, as shown in FIG. 2, the individual blade members are disposed at uniform phase angle spacing in the top view. FIG. 2 shows the FIG. 1 drive power apparatus 10 in the state after counter clockwise rotation by 240 degrees. This predetermined angle is obtained by dividing 180 degrees by the number of pairs of first and second blade members (i.e., number of stages) (or in the case where the first and second blade members are disposed such that two or more thereof are overlapped, a multiple of (i.e., two, three times, . . . ) that angle. For example, in the case of three pairs of first and second blade members (i.e., three pairs and three stages) disposed without overlap (i.e., in three stages), the predetermined angle is 60 as shown in FIG. 2.

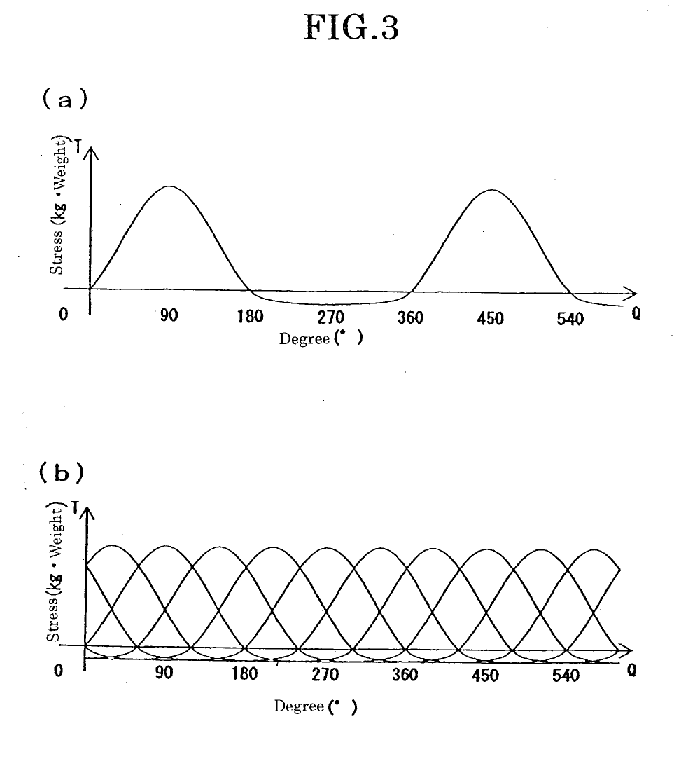

With the above first an second blade members 19 to 24, output characteristics as shown in FIGS. 3(a) and 3(b), for instance, are obtainable. FIGS. 3(a) and 3(b) show the output characteristics of either ones of the first and second blade members 19 to 24, and the output characteristics of the other blade members are deviations of the phases of the output characteristics shown in FIG. 3(a) and 3(b) by 180 degrees. The output characteristics of the other blade members are not shown to evade unclarity of drawings. FIG. 3(a) shows the output characteristic of a single blade member, which assumes the vertical state when the rotation angle of the vertical shaft 12 is 90 degrees and assumes the horizontal state when the rotation angle of the vertical shaft 12 is 270 degrees. FIG. 3(b) shows the output characteristics of a plurality of blade members (i.e., here either three of the first and second blade members).

As shown in FIG. 3(a), the blade member can output the maximum stress in the vertical state of its plane, and its output stress is gradually attenuated as its plane undergoes state change from the vertical state to the horizontal state. When its plate state is in the horizontal state, the blade member receives wind resistance and comes to output negative stress and acts as a brake. Therefore, with a single blade member the output characteristic of the drive power apparatus 10 fluctuates as shown in FIG. 3(a). Specifically, the blade member can output the maximum stress when and only when the rotation angle of the vertical shaft is 90 degrees, 240 degrees and so forth. On the other hand, in the case of a plurality of blade members, some of these blade members receive wind power, and the drive power apparatus 10 thus receives wind power more uniformly. Thus, as shown in FIG. 3(b), the drive power apparatus 10 can obtain a flat output characteristic, that is, a characteristic of outputting the maximum stress or stress close thereto with any rotation angle of the vertical shaft 12, and the vertical shaft 12 can be rotated smoothly.

Thus, in the case of a plurality of blade members, the efficiency is better than in the case of a single blade member. Likewise, in the case of a plurality of pairs of first and second blade members, the efficiency is better than in the case of a single pair.

The blade members are preferably arranged as pairs in 180 degree symmetry with respect to the center of the vertical shaft 12 for the following ground.

In the case of a single blade member, the vertical shaft 12 supports the blade member in the so-called cantilever fashion. On the other hand, in the case of a pair of blade members, the vertical shaft 12 supports the blade members in the two sides. The rotational moment is different in the cases of the cantilever support and two side support by the vertical shaft 12, and is low in the two side support case than in the cantilever support case. Forth is reason, it is preferable to dispose two blade members as a pair in the 180 degree symmetry arrangement with respect to the center of the vertical shaft 12.

With the 180 degree symmetry arrangement of the first blade members 20, 21 and 23 and the second blade members 20, 22 and 24 with respect to the center of the vertical shaft, only a single blade member is present in one horizontal plane. Thus, the first and second blade members 19 to 24 each never come to be leeward of other blade members, and never act as brakes. In the drive power apparatus 10, the first and second blade members 19 to 24 are smoothly operable and, in consequence, it is possible to obtain improved rotational efficiency of the vertical shaft 12. For this reason, it is a gain preferable to dispose two vertical blades as a pair in the 180 degree symmetry arrangement with respect to the center of the vertical shaft 12.

In the FIG. 1 arrangement, the first and second blade members 19 to 24 are disposed helically, but the same rotational efficiency of the vertical shaft 12 is obtainable with arrangements other than the helical one as well so long as the first and second blade members 19 to 24 are arranged uniformly at a predetermined angular interval. However, the first and second blade members 19 to 24 are sequentially disposed upward stage by stage, the helical arrangement is preferable from the consideration of the readiness of balancing the individual members at the time of the installation and the readiness of the angle adjustment.

The construction of the drive power apparatus 10 will now be described in details.

The base 11 has a frame 25, which is anchored secured to a foundation (not shown). Bearings 26 and 27 in charge of radial and thrust loads are secured to the frame 25. The vertical shaft 12 is mounted upright in the bearings 26 and 27. The base 11 accommodates the electric power generator 29 secured as drive power mechanism to the frame 25.

The vertical shaft 12 has a pulley 28 provided on its part and coupled via a belt 31 to a pulley 30 provided on the input shaft of the power generator 29. The rotation of the vertical shaft 12 is transmitted to the input shaft of the power generator 29 to cause rotation thereof for electric power generation.

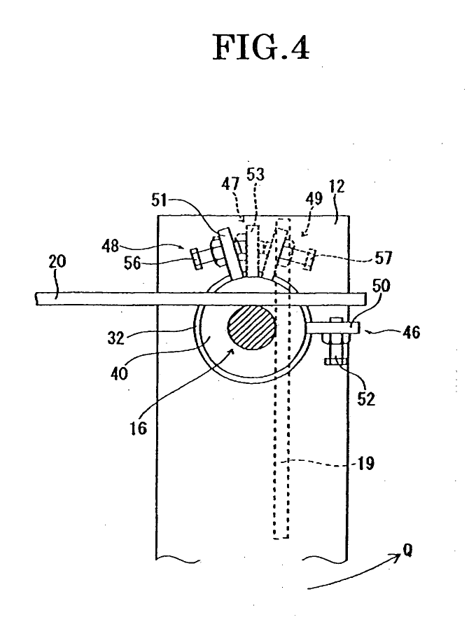

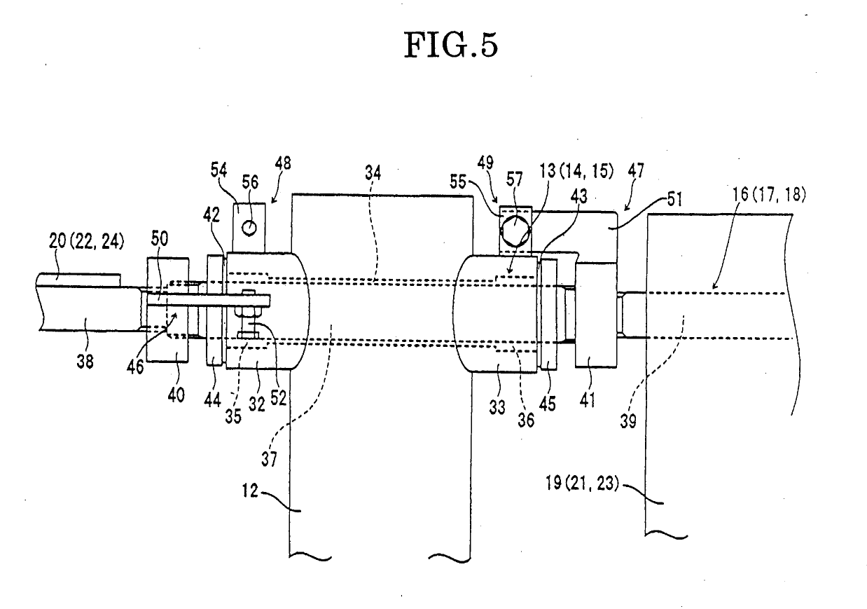

Bearing parts 13 to 15 are provided on the vertical shaft 12 and spaced apart a distance greater than the height h of the first and second blade members 19 to 24. As shown in FIGS. 4 and 5, the bearing parts 13 to 15 each have bosses 32 and 33 provided on both diametrically opposite sides and also have a thorough bore 34 penetrating the vertical shaft 12. The thorough bore 34 has opposite flared end parts, in which bushes 35 and 36, as an example of bearings, are provided. FIG. 4 is an enlarged-scale front view showing a part P in FIG. 1, and FIG. 5 is an enlarged-scale side view showing the part P in FIG. 1. The thorough bore 34 is penetrated by each of the horizontal shafts 16 to 18. The horizontal shafts 16 to 18 each has a main shaft part 37 penetrating the central thorough bore 34 and projecting shaft parts 38 and 39 provided at the opposite ends of the main shaft part 37, these parts 38 to 39 being secured to one another by coupling members 40 and 41. The horizontal shaft 16 is rotated in the bearing part 13 with low frictional resistance.

In this embodiment, the bearing parts 13 to 15 each have flat bushes 42 and 43 provided on diametrically opposite sides for receiving thrust load. To the main shaft part 37 of each of the horizontal shafts 16 to 18, ring members 44 and 45 are secured in contact with the flat bushes 42 and 43, respectively. The ring members 44 and 45 serve to prevent lateral movement of the main shaft part 37 and receive the thrust load generated on the main shaft part 37.

On the both sides of the coupling members 40 (or 41) securing the main shaft part 37 of the horizontal shaft 16 (17 and 18) and the projecting shaft parts 38 (or 39) the internal thread is formed. To this internal thread the external threads formed on the end of the main shaft part 37 and the inside end portion of the projecting shaft parts 38 (or 39) are firmly screwed.

The first and second blade members 19 and 20 are secured to the extensions 39 and 38 of the horizontal shaft 16 such that they are deviated from each other by an angle of 90 degrees about the horizontal shaft 16. The first and second blade members 19 and 20 are formed from a plastic, wood or metal plate.

The horizontal shaft 16 has a mechanism for restricting the rotation angle of the horizontal shaft 16 substantially to a range of 90 degrees (see FIGS. 4 and 5). Specifically, the horizontal shaft 16 has a first and a second contact member (i.e., example of touching members) 46 and 47 provided on the opposite sides of the bearing part 13 as center, and also has a first and a second contactable member (i.e., example of receiving members) 48 and 49 also provided on the opposite sides of the bearing part 13 and capable of being brought into contact with the first and second contact members 46 and 47. With this arrangement, the horizontal shaft 16 is capable of being rotated substantially in a range of 90 degrees.

Specifically, as shown in FIGS. 4 and 5, in the horizontal shaft 16 the first contact member 40 is provided on the coupling member 40, and the second contact member 48 is provided on the other coupling member 41. The first and second contact members 46 and 47 respectively have substantially L-shaped members 50 and 41, contact bolts 52 and 53 provided on the ends of the members 50 and 51, and anti-loosening nuts screwed on the contact bolts 52 and 53.

On the other hand, the first and second contactable members 48 and 49 provided on the opposite sides of the bearing part 13 have rectangular plate members 54 and 55, contactable bolts 56 and 57 screwed therein, and anti-loosening nuts screwed on the contactable bolts 56 and 57.

Although in this embodiment the first and second contact members 46 and 47 and the first and second contactable members 48 and 49 have the contact bolts 52 and 53 and contactable bolts 56 and 57, respectively, for fine adjustment of the stop angle concerning the plane orientations of the first and second blade members 19 and 20, such fine adjustment is not essentially necessary (in this case the first and second contact members 46 and 46 and the first and second contactable members 48 and 49 being preferably disposed in the inside of the bearing part 13.

The bearing parts 14 and 15 on the other horizontal shafts 17 and 18, like the horizontal shaft 16, are each provided with a mechanism or restricting the rotation angle of each of the horizontal shafts 17 and 18 to a substantial angle of 90 degrees.

Although in the FIG. 2 arrangement three pairs of first and second blade members are disposed as three stages one above another, the number of horizontal shafts are by no means limitative to three, and it is possible to provide only a single pair or a plurality of pairs including three pairs. Where a plurality of horizontal shafts are provided, these horizontal shafts are preferably disposed in a vertically spaced-apart relation to one another for preventing interference of the blade members to one another.

The first and second blade members 19 to 24 of the drive power apparatus 10 utilizing winds, which has the above construction, are operable as follows.

At the no load no wind time, the first and second blade members 19 to 24 remain stationary with their plane orientations at a downward angle of 34 degrees from horizontal plane. When the first and second blade members 19 to 24 receive wind in this state, they function such that one of them receive wind power. It is now assumed that the first and second blade members 19 to 24 are in their positions as shown in FIG. 2. At this time, the planes of the first blade members 19, 21 and 23 are directed in the direction to receive wind W (i.e., vertical direction with maximum resistance of wind W), and the planes of the second blade members 20, 22 and 24 are directed in the direction to pass wind W (i.e., horizontal direction with resistance of wind W). The first blade members 19, 21 and 23 receiving the power of wind W pushes the horizontal shafts 16 to 18 in a predetermined direction (i.e., counterclockwise direction at this time), and the horizontal shafts 16 to 18 thus rotate the vertical shaft 12.

Subsequently, when the first blade member 23 reaches leeward position R to be parallel with the direction of flow of wind W, its plane orientation is gradually changed from the direction to receive wind W (i.e., vertical direction) to the direction to pass wind W (i.e., horizontal direction), and in an interlocked relation, the plane orientation of the second blade member 24 is changed from the direction to pass wind W (i.e., horizontal direction) to the direction to receive wind W (i.e., vertical direction) When the second blade member 24 comes to receive the power of wind W, the second blade member 24 this time pushes up the first blade member 23 in the horizontal direction and receive the power of wind W to push the horizontal shaft 18 in a predetermined direction and rotate the vertical shaft 12. At this time, the blade members 19 and 21 also receive the power of wind W and push the horizontal shafts 16 and 17 in a predetermined direction and rotate the vertical shaft 12. Subsequently, when the first blade member 21 reaches leeward position R to be parallel with the direction to pass wind W, the next first and second blade members 19 and 22, the horizontal shaft 17 and the vertical shaft 12 operate likewise. Subsequently, when the next first blade member 19 reaches leeward position R to be parallel to the direction of flow of wind W, the next first and second blade members 19 and 20, the horizontal shaft 16 and the vertical shaft 12 operate likewise.

Subsequently, the first and second blade members 19 to 24 come to a state brought about by one half rotation of them from the state shown in FIG. 2. At this time, the planes of the second blade members 20, 22 and 24 are directed in the direction to receive wind W (i.e., vertical direction), and the planes of the first blade members 19, 21 and 23 are directed in the direction to pass wind w (i.e., horizontal direction). The second blade members 20, 22 and 24 which receive the power of wind W, push the horizontal shafts 16 to 18 in a predetermined direction, which in turn rotate the vertical shaft 12.

Subsequently, the second blade member 24 reaches leeward position R to be parallel to the direction of passing wind W, thus causing gradual change in the plane orientation of the second blade member 24 from the direction to receive wind W (i.e., vertical direction) to the direction of passing wind W (i.e., horizontal direction) and, in an interlocked relation to this change, causing the plane orientation of the first blade member 23 to undergo a change from the direction to pass wind W (i.e., horizontal direction) to the direction to receive wind W (i.e., vertical direction) When the first blade member 23 comes to receive the power of wind W, this time it pushes up the second blade member 24 in the horizontal direction, and also by receiving the power of wind W it pushes the horizontal shaft 18 in a predetermined direction and rotate the vertical shaft 12. At this time, the second blade members 20 and 22 receive the power of wind W and push the horizontal shafts 16 and 17 in a predetermined direction, thus rotating the vertical shaft 12. Subsequently, when the next second blade member 22 reaches leeward position R to be parallel to the direction of flow of wind W, the next second and first blade members 22 and 21, the horizontal shaft 17 and the vertical shaft 12 operate likewise. Subsequently, when the next blade member 20 reaches leeward position R to be parallel to the direction of flow of wind W, the next second and first blade members 20 and 19, the horizontal shaft 16 and the vertical shaft 12 operate likewise.

Subsequently, the first and second blade members 19 to 24 alternately repeat like operation to rotate the vertical shaft 12. This operation of the first and second blade members 19 to 24 is realized by the horizontal shafts 16 to 18 penetrating the vertical shaft 12. Since the first blade members 19, 21 and 23 and the second blade member 20, 22 and 24 operate in an interlocked relation to one another (i.e., by utilizing the movements of one another), the resultant operation is obtained very smoothly and with little energy loss.

Concerning this embodiment of the drive power apparatus 10 utilizing winds, experiments were conducted with the rotation speed of the vertical shaft 12 set to 10 to 120 rpm and the rocking cycle of the horizontal shafts 16 to 18 set to 10 to 120 times/min., but these values are by no means limitative.

As the drive power apparatus 10 operates, the above angle restricting mechanism (see FIGS. 4 and 5) operate as follows.

Referring to FIGS. 4 and 5, the plane orientation of the first blade member 19 is in the vertical direction, and the plane orientation of the second blade member 20 is in the horizontal direction. At this time, the second contact member 47 is in contact with the second contactable member 49, thus restricting the plane orientations of the first and second blade members 19 and 20.

The first blade member 19 receiving wind power in this state pushes the horizontal shaft 16 in a predetermined direction of rotation (here counterclockwise direction). When the horizontal shaft 16 exceeds leeward position R shown in FIG. 2, the first blade member 19 comes to receive wind W from the back side. Thus, the first blade member 19 starts rotation in the direction of arrow Q as shown in FIG. 4. This rotation is transmitted via the horizontal shaft 16 to the second blade member 20, thus causing shift of the plane orientation of the upwind second blade member 20 from the horizontal direction to the vertical direction. Now, the second blade member 20 comes to receive the power of wind W. This time, the second blade member 20 acts to push up the first blade member 19 in the horizontal direction. At this time, the first contact member 46 is brought into contact with the first contactable member 48, thus restricting the plane orientation of the first and second blade members 19 and 20. The first blade members 21 and 23 and the second blade members 22 and 24 provided on the lower horizontal shafts 17 and 28, respectively, operate likewise.

(Construction of the Blade Members)

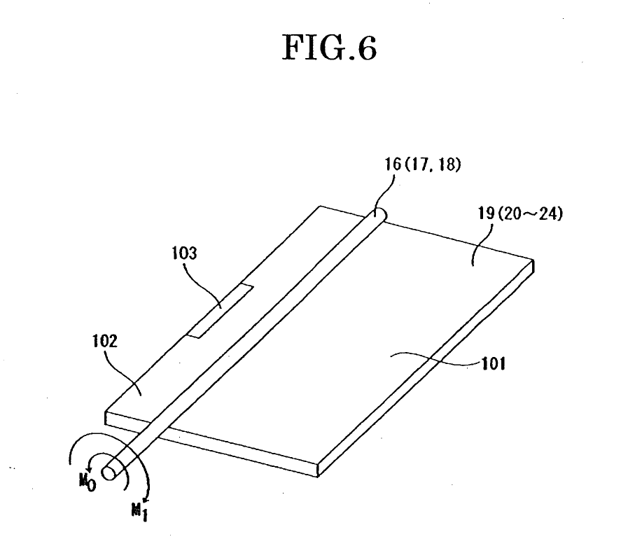

FIG. 6 shows the structure of the blade member 19. The other blade members 20 to 24 also have the same structure.

In the FIG. 6 example, the blade member 19 is made of a single material and has a rectangular form with a uniform thickness in all parts, and it is secured not at an end but at an intermediate position to the horizontal shaft 19. However, the blade member 19 is eccentrically secured to the horizontal shaft 16 and has a load member 103 provided to ensure its stable operation.

Although in the FIG. 6 example, the blade member 19 is eccentrically secured to the horizontal shaft 16, this is made so in order that the two parts of the blade member 19, which are defined by the horizontal shaft 16 (one of these parts being referred to as first section and the other as second section) receive power of different magnitudes from wind. With the blade member 19, which is made of a single material and has a rectangular form with a uniform thickness in all parts, the first and second sections are identical unless the blade member 19 is eccentrically secured to the horizontal shaft 16. However, where the first and second sections of the blade member 19 are made of different materials, or have different thickness, or have unique shapes different from each other, they receive power of different magnitudes from wind. Thus, in these cases the blade member 19 may be concentrically secured to the horizontal shaft 16.

In the FIG. 6 example, the blade member 19 is eccentrically secured to the horizontal shaft 16. This means that the blade member 19 has a part having a large area 101 (i.e., large area part) and a part having a small area 102 (i.e., small area part) Sometimes, the large area part may be referred to as long part, and the small area part may be referred to as short part.

A rotation momentum M₁ about the horizontal shaft 16, which is generated by gravitational force, is applied to the centroid of the large area part 101. A rotational momentum M₂ about the horizontal shaft 16, which is generated by gravitational force in the direction opposite to the direction in the case of the rotation momentum M₂, is applied to the centroid of the small areas part 102. Since the rotation momentum M₂ is less than the rotation momentum M₁, a load for securing the stable operation of the large area part 101 has to be provided to the small area part 102. In the FIG. 6 example, the load member 103 is accordingly provided to the small area part 102.

In the FIG. 6 example, the load member 103 is made of a material having a higher specific gravity than that of the material of the blade members 19 to 24, and is buried in the small area part 102. The load member 103 may be provided on the blade member 19 instead of being buried in the blade member 19. In this case, the load member 103 need not be made of a material having a higher specific gravity than that of the material of the blade member 19, but may be made of a material having an equal or lower specific gravity. The load member 103 may not have the shape as shown in FIG. 6 but may have any desired shape. It is thus possible, for instance, to form the load member 103 by the same material and of the same shape as the small area part 102 and mount this load member 103 on the small area part 102.

As shown above, in the FIG. 6 example with balance adjustment is made with respect to the rotation momentums. The weight balance adjustment, however, has to be made by taking various points into considerations. Now, the weight balance adjustment will be described.

(Weight Balance Adjustment)

First, a summary of the weight balance adjustment will be described.

The first and second blade members 19 to 24 change their plane orientations by utilizing wind energy. At this time, great consumption of wind energy by the first and second blade members 19 to 24 results in reduced efficiency for conversion of the wind energy to the rotational power. The first and second blade members 19 to 24 are thus preferably arranged such that they consume as less wind energy as possible when they change their plane orientations. In other words, it is preferable to minimize wind energy consumption by the first and second blade members 19 to 24 in the plane orientation changes.

Quantities relevant to the wind energy consumed by the first and second blade members 19 to 24 in the plane orientation change are the rotation momentum about the horizontal shafts 16 to 18 generated by the gravitational forces, and the inertial momentum of the first and second blade members 19 to 24.

The rotation momentums around the horizontal shafts 16 to 18 generated by the gravitational force are preferably as low as possible (preferably zero or a value close thereto). For making the rotation moments to be as low as possible, the load member 10, for instance, is disposed in the small area part 102. By so doing, the weight balance adjustment of the first and second blade members 19 to 24 are made. At this time, the load member 103 is preferably disposed, at a position as close to each of the horizontal shafts 16 to 18 as possible for the following reason.

It is now assumed that the first and second blade members 19 to 24 are disposed on end parts of the horizontal shafts 16 to 18. At this time, the rotation momentums of the first and second blade members 19 to 24 are so high that the wind energy is mostly consumed for rotating the first and second blade members 19 to 24. Therefore, the rotation efficiency of the vertical shaft 12 is low.

To make the rotation momentums of the first and second blade members 19 to 24, the horizontal shafts 16 to 18 may be disposed centrally of the first and second blade members 19 to 24.

In this case, however, the same rotation momentums by gravitational force are applied to the two parts defined by the horizontal shafts 16 to 18, i.e., first and second sections, of the first and second blade members 19 to 24. Therefore, at the time of no load and no wind, the first and second blade members 19 to 24 are not stopped with their plane orientation angle of 45 degrees downward from horizontal plane, and their operation at the time of start of rotation is unstable. Also, since the first and second sections have the same area, they receive wind power of the same magnitude. Therefore, the first and second blade members 19 to 24 about the horizontal shafts 16 to 18 are rotated in indefinite directions, so that their stable rotation cannot be obtained. This results in rotation efficiency reduction of the vertical shaft 12.

Thus, it is arranged such that the first and second sections have different areas and thus receive wind power of different magnitudes. With this arrangement, the first and second blade members 19 to 24 are rotated in a predetermined direction about the horizontal shafts 16 to 18.

In this case, however, differences are produced between the weights of the first and second sections and also between the distance of the balance center (centroid) of the first section from each of the horizontal shafts 16 and 18 and the distance of the centroid of the second section from each of the horizontal shafts 19 to 24. Therefore, a difference is produced between the rotation momentums of the first and second sections of the first and second blade members 19 to 24.

Accordingly, weight balance adjustment of the first and second blade members 19 to 24 is made with a load provided to the low rotation momentum section side to equalize the rotation momentums of the first and second sections. For example, the load member 103 is disposed in part of full low rotation momentum section, thus making the rotation momentums of the first and second blade members 19 to 24 as low as possible. The first and second blade members 19 to 24 after the weight balance adjustment with respect to the rotation momentums now can be smoothly rotated about the horizontal shafts 16 to 18.

With the above weight balance adjustment with respect to the rotation momentums, either one of the first and second sections becomes heavier. This means inertial momentum increase of the first and second blade members 19 to 24. The inertial momentum is proportional to the square of the distance of the centroid from the center of rotation, while the rotation momentum is proportional to the distance of the centroid from the center of rotation. To minimize the inertial momentum increase, the distance of the load application position from the horizontal shafts 16 to 18 is made as small as possible (preferably zero or a value close thereto). In this way, the weight balance of the first and second blade members 19 to 24 with respect to the inertial momentums is adjusted.

The first and second blade members 19 to 24, of which the weight balances with respect to the rotation momentums and the inertial momentums have been adjusted, are rotated about the horizontal shafts 16 to 18 in a predetermined direction, and at this time they are rotated more smoothly without substantially consuming the wind energy. In consequence, the rotation efficiency of the vertical shaft 12 is improved.

(Formulas Concerning the Weight Balance Adjustment)

Now, the weight balance adjustment will be described in detail by using arithmetic equations.

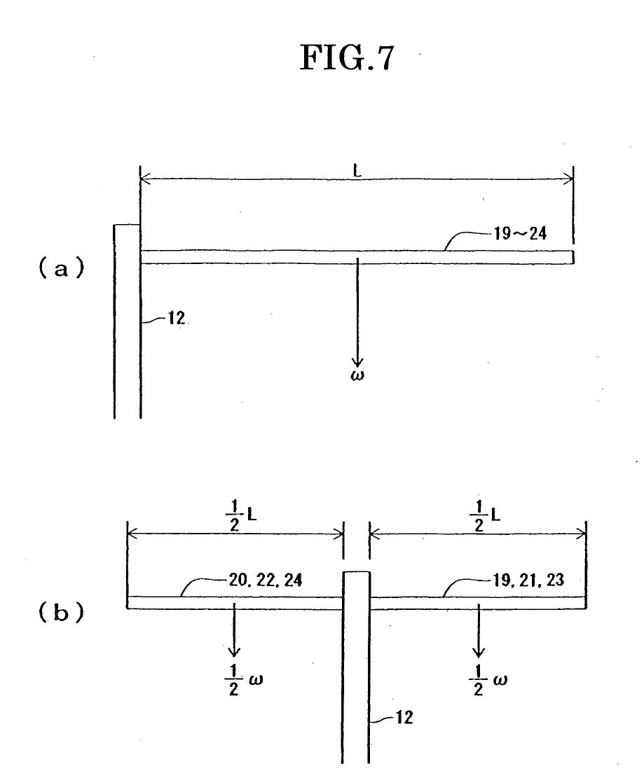

In the drive power apparatus 10, the rotation momentum I about the vertical shaft 12 is different in the cases of the cantilever support and the double side support of the blade members by the vertical shaft 12. Specifically, the rotation momentum I is calculated with different calculation formulas in the case that the stems (i.e., ends) of the horizontal shafts 16 to 18 are support points as shown in FIG. 7(a) and in the case that intermediate parts of the horizontal shafts 16 to 18 are support points. In the former case the rotation momentum I is calculated by the following equation (1), and in the latter case it is calculated by the following equation (2). FIGS. 7(a) an 7(b) are views showing the positions of support points of the horizontal shafts. In FIGS. 7(a) and 7(b), the length of the horizontal shafts 16 to 18 is denoted by L, and the weight of the horizontal shafts 16 to 18 first and second blade members 19 to 24) is denoted by W.

I=1/2×L×ω (1)

I=(1/4×L×ω)−(1/4×L×ω)=O (2)

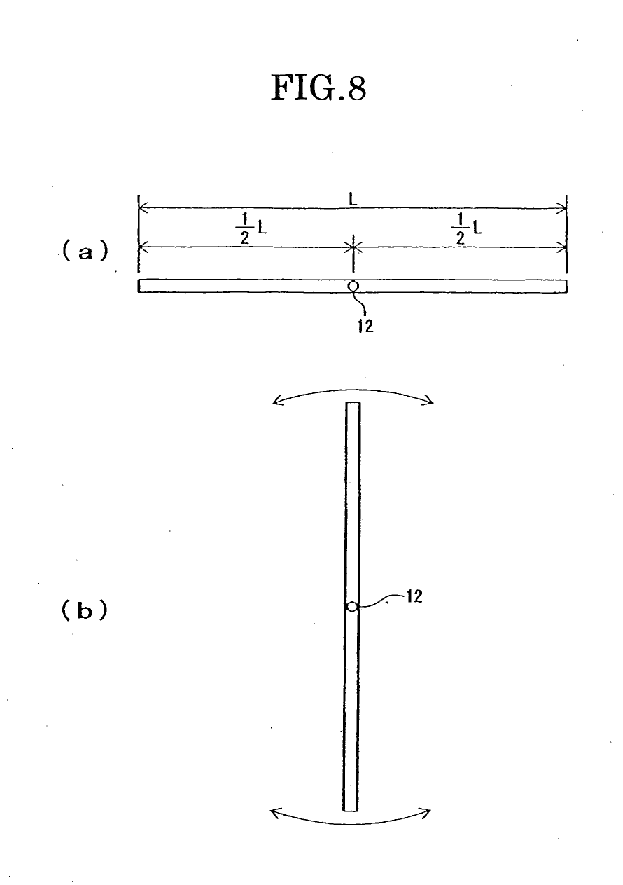

As is obvious from the comparison of the equations (1) and (2), the rotation momentum I may be made lower in the case that the stems (i.e., ends) of the horizontal shafts 16 to 18 are support points than in the case that intermediate parts of the horizontal shafts 16 to 18 are support points. As shown in FIG. 8(b), the rotation momentum I is minimum in the case that the center of each of the horizontal shafts 16 to 18 is the support point. In this case, as shown in FIG. 8(b), the horizontal shafts 16 to 18 are smoothly rotated about the vertical shaft 12. Thus, the drive power apparatus 10 preferably has the arrangement as shown in FIGS. 8(a) and 8(b). FIGS. 8(a) and 8(b) are views showing the position of support point of the horizontal shafts. FIG. 8(a) shows the position of support point of the horizontal shafts 15 to 18, and FIG. 8(b) shows the operation of the horizontal shafts 16 to 18.

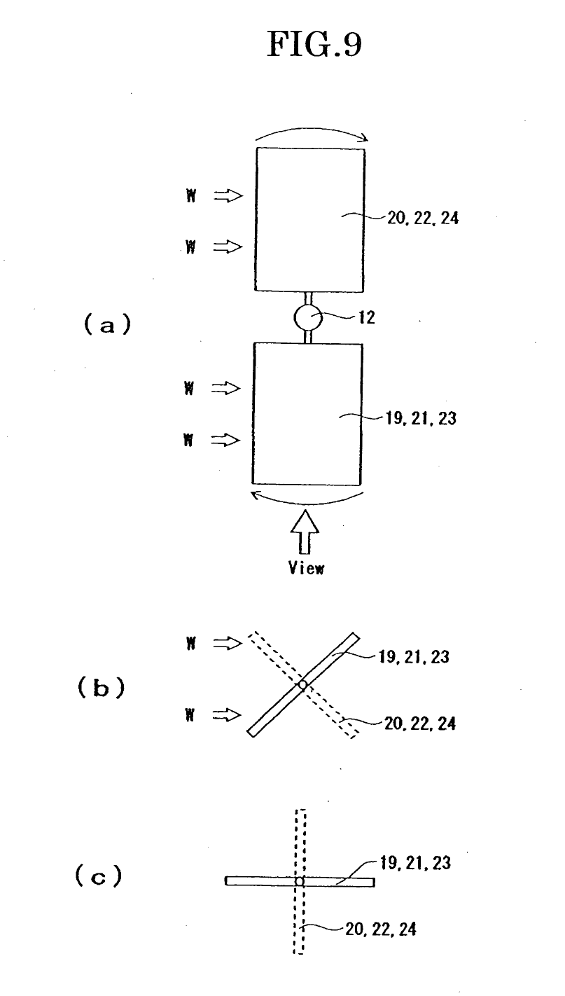

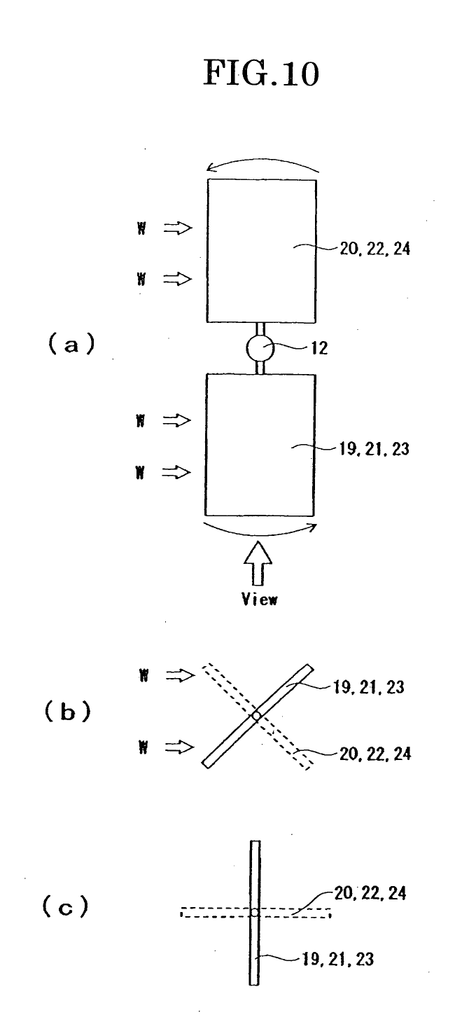

The first and second blade members 19 to 24 of the drive power apparatus 10, in which the center of each of the horizontal shafts 16 to 18 is the support point, operate as shown in FIGS. 9(a) to 9(c) or FIGS. 10(a) to 10(c). Specifically, in the case of the clockwise rotation, the blade members 19 to 24 operate as shown in FIGS. 9(a) to 9 (c), and in the case of the counterclockwise rotation they operate as shown in FIGS. 10(a) to 10(c). FIGS. 9(a) to 9(c) are views showing the operation of the blade members. Specifically, FIG. 9(a) is a top view showing the arrangement of the pairs of the first and second blade members 19 to 24, FIG. 9(b) is a view, taken in the direction of arrow Vie in FIG. 9(a), showing the arrangement of the pair of first and second blade members 19 to 24, and FIG. 9(c) is a view showing the state of the pairs of first and second blade members 19 to 24 shown in FIGS. 9(a) and 9(b) after rotation of 45 degrees caused as a result of receiving wind W. Likewise, FIGS. 10(a) to 10(c) are views showing the operation of the blade members. Specifically, FIG. 10(a) is a top view showing the arrangement of the pairs of blade members 19 to 24, FIG. 10(b) is a view, taken in the direction of arrow Vie in FIG. 10(a), showing the arrangement of the pairs of first and second blade members 19 to 24, and FIG. 10(c) is a view showing the state of the pairs of first and second blade members 19 to 24 shown in FIGS. 10(a) and 10(b) after rotation by 45 degrees caused as a result of receiving wind W.

For minimizing the wind energy consumed in the plane orientation change of the first and second blade members 19 to 24, the rotation momentums M applied by gravitational forces to the first and second blade members 19 to 24 (hereinafter referred to merely as rotation momentums) and the inertial momentums N of the first and second blade members 19 to 24 (hereinafter referred to merely as inertial momentums) may be minimized.

As described above, for wind energy minimization the rotation momentums M applied by gravitational forces to the first and second blade members 19 to 24 are made as low as possible. The rotation moment will now be described in detail.

(Rotation Moment)

The first and second blade members 19 to 24 have to be formed such that the first and second sections receive power of different magnitudes from wind. This is so because when the first and second sections receive the same magnitude from wind power, the first and second blade members 19 to 24 are rotated not in a fixed direction, and they repeat alternate clockwise and counterclockwise rotation operations, thus failing to obtain sufficient rotation of the horizontal shafts 17 to 18. For example, a drive power apparatus 10, the first and second blade members 19 to 24 are formed such that the first and second sections receive power of the same magnitude from wind, can not generate sufficient electric power in its use as a wind electric power generator or the like. Also, even if such a drive power apparatus is a multiple stage one, the horizontal shafts 16 to 18 may not be rotated or, may be rotated, if any, in mixed opposite directions and act to cancel the rotation drive power. For this reason, the efficiency of conversion of the wind energy to the rotational drive force of the vertical shaft 12 is extremely reduced. As a result, the first and second blade members 19 to 24 have to be formed such that the first and second sections receive power of different magnitudes from wind.

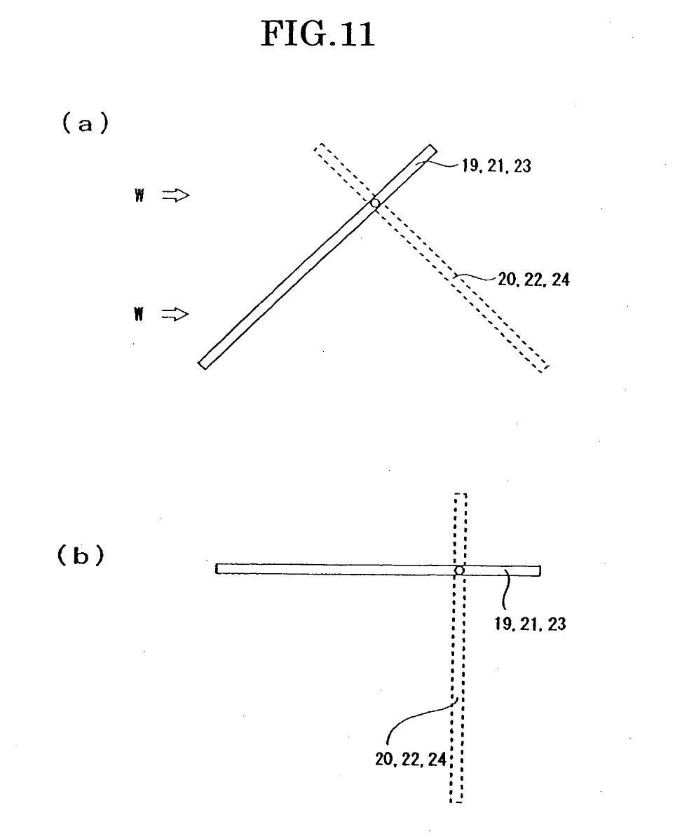

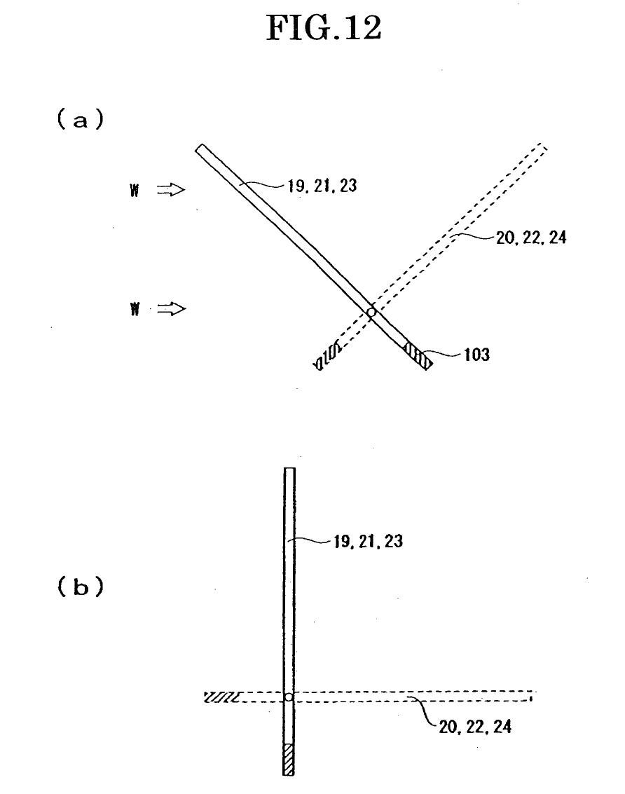

Accordingly, as shown in FIGS. 11 and 12, the position of fulcrum of each of the first and second blade members 19 to 24 is not set to the center but set to a position deviated therefrom. FIGS. 11(a) and 11(b) show the position of support point. Specifically, FIG. 11(a) shows the arrangement of the first and second blade members 19 to 24 in the stationary state, and FIG. 11(b) shows the arrangement of the first and second blade members 19 to 24 in a state after rotation by 45 degrees from the state shown in FIG. 11(a). Likewise, FIGS. 12(a) and 12(b) show the arrangement of the first and second blade members 19 to 24 in the stationary state. Specifically, FIG. 12(a) shows the arrangement of the first and second blade members 19 to 24 in the stationary state, and FIG. 12(b) shows the arrangement of the first and second blade members 19 to 24 in a state after rotation by 45 degrees from the state shown in FIG. 12(a). FIGS. 11(a) and 11(b) and FIGS. 12(a) and 12(b), like the example shown in FIGS. 9(a) to 9(c), show an example of clockwise rotation of the vertical shaft 12.

In the example shown in FIG. 11(a) and 11(b), the first and second blade members 19 to 24 are mounted on the horizontal shafts 16 to 18 eccentrically (i.e., not at the center but at a position deviated therefrom). With such first and second blade members 19 to 24, the long part is heavier than the short part. Thus, at the time of no load and no wind, the long part is located beneath the short part, and the blade members 19 to 24 are stopped with their plane orientations of a downward angle of 45 degrees from horizontal plane.

In the example shown in FIGS. 12(a) and 12 (b), while the first and second blade members 19 to 24 are mounted eccentrically on the horizontal shafts 16 to 18, the weight member 103 is disposed on the long part side. The load member 103 makes the short part of each of the first and second blade members 19 to 24 to be heavier than the long part thereof. Thus, at the time of no load and no wind, the short part is located beneath the long part, and the blade members 19 to 24 are stopped with their plane orientations at a downward angle of 45 degrees from the horizontal plane.

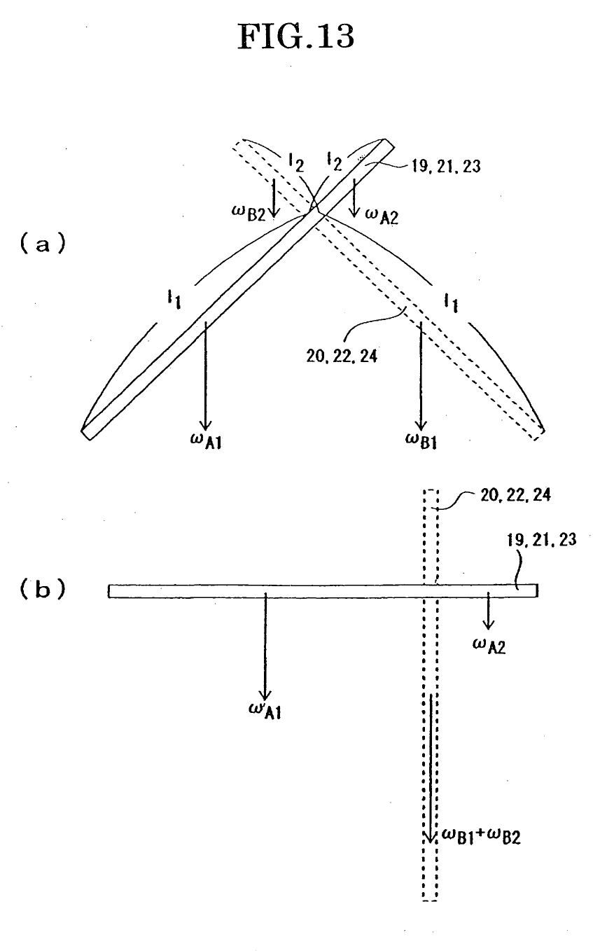

By the way, as shown in FIGS. 3(a) and 3(b), gravitational forces act on each of the first and second blade members 19 to 24 mounted on the horizontal shafts 16 to 18. FIGS. 13(a) and 13(b) are views showing the action of gravitational force. Specifically, FIG. 13(a) shows the action of gravitational force in the state shown in FIG. 11(a), and FIG. 13(b) shows the action of gravitational force in the state shown in FIG. 11(b). While FIGS. 13(a) and 13 (b) show the action of gravitational force by taking the case of FIGS. 11(a) and 11(b) as an example, the same also applies to the arrangement shown in FIGS. 12(a) and 12(b).

In the state shown in FIG. 13(a), rotation moment M given by the following equation (3) is applied to the first and second blade members 19 to 24. Also, in the state shown in FIG. 13(b), rotation moment M given by the following equation (4) is applied to the first and second blade members 19 to 24. Here, the lengths of the long and short parts of the first and second blade members 19 to 24 are represented by I₁ and I₂, respectively, the weights of the long and short parts of the first blade members 19, 21 and 23 are represented by ω_{A1} and ω_{A2}, respectively, and the weights of the long and short parts of the second blade members 20, 22 and 24 are represented by ω_{B1} and ω_{B2} respectively.

$$\begin{matrix}M = ( 1 / 2 \times {l}_{1} \times {ω}_{Al} \times SIN 45 ° + 1 / 2 \times {l}_{2} \times {ω}_{B2} \times SIN 45 ° ) - ( 1 / 2 \times {l}_{2} \times {ω}_{A2} \times SIN 45 ° + 1 / 2 \times {l}_{1} \times {ω}_{Bl} \times SIN 45 ° ) & ( 3 ) \\ M = ( 1 / 2 \times {l}_{1} \times {ω}_{Al} ) - ( 1 / 2 \times {l}_{2} \times {ω}_{A2} ) & ( 4 )\end{matrix}$$

As is obvious from FIG. 13(b), the rotation momentums of the long and short parts of the first and second blade members 19 to 24 are different, the rotation momentum M cannot be minimized.

According to the present invention a load is applied to the short part, i.e., lower rotation momentum part, of the first and second blade members 19 to 24 to equalize the rotation momentums of the long and short parts. The weight balance adjustment of the first and second blade members 19 to 24 is thus made to have the rotation momentum calculated by the equation (4) zero.

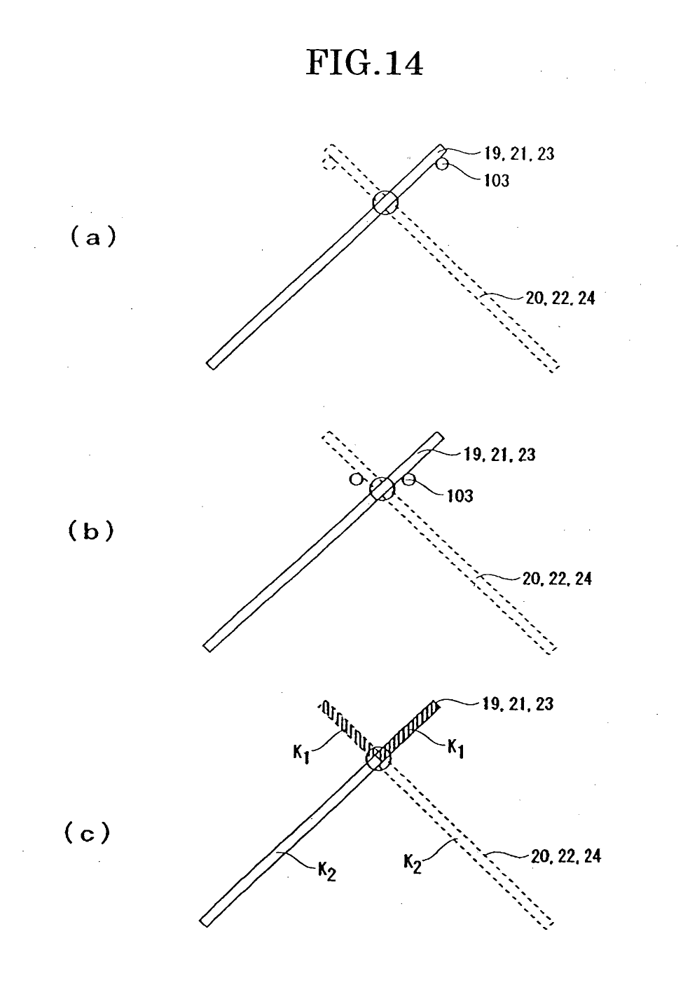

A simple way of the weight balance adjustment is to make either one of the first and second sections to be heavier in weight per unit time than the other. An example is shown in FIGS. 14(a) to 14(c). FIGS. 14(a) to 14(c) are views showing this way of weight balance adjustment. Specifically, FIG. 14(a) shows disposition of the load member 103 in the short part of the first and second blade members 19 to 24 on the outer end side (i.e., the side remoter from the horizontal shafts 16 to 18) thereof. FIG. 14(b) shows disposition of the load member 103 in the short part of the first and second blade members 19 to 24 on the inner end side (i.e., the side closer to the horizontal shafts 16 to 18) thereof. FIG. 14(c) shows an arrangement, in which a material having a lower specific gravity than that of the long part K₁ of the first and second blade members 19 to 24 is used for the short part K₂. As suitable weight balance adjustment method, the short part K₁ may be made thicker than the long part K₂, or the short part K₁ may be formed to have a multiple layer structure by laminating a plurality of blade members.

In the above way, the first and second blade members 19 to 24 after the weight balance adjustment with respect to the rotation momentums are rotated smoothly about the horizontal shafts 16 to 18.

However, by such weight balance adjustment with respect to the rotation momentums, either one of the first and second sections (i.e., short part here) of the first and second blade members 19 to 24 becomes heavier, and its inertial momentum is increased.

As shown above, for minimizing the wind energy it is preferable to make the inertial momentum as small as possible. Now, the inertial momentum will be described.

(Inertial Momentum)

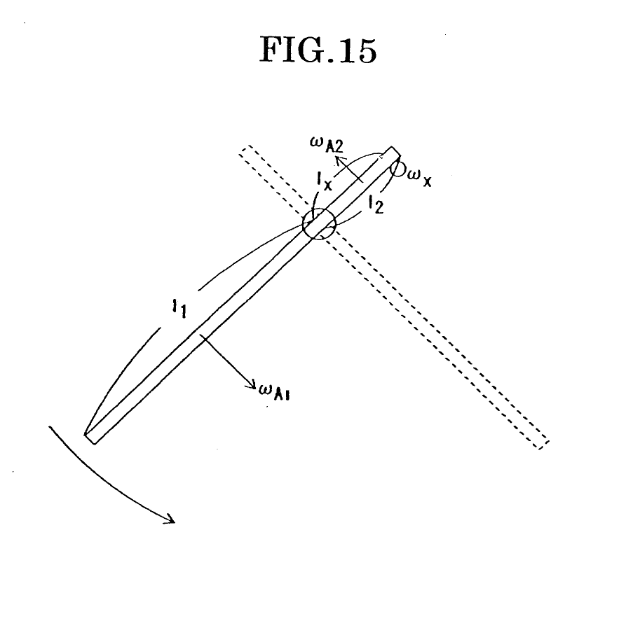

The rotation momentum on the first and second blade members 19 to 14 in the state as shown in FIG. 15 will now be described in the following equation (5).

M=(1/2×I₁×ω_{A1})−((1/2×I₂×ω_{A2})+(1/2×Iₓ×ωₓ))=0 (5)

The inertial momentum of the first and second blade members 19 to 24 in the state shown in FIG. 15 is the sum of the product of the weight of the long part and the square of the distance of the horizontal shafts 17 to 18 from the centroid of the long part, the product of the weight of the short part and the square of the distance of the horizontal shafts 16 to 18 from the centroid of the short part and the product of the weight of the load member 103, which is provided as weight increase by the weight balance adjustment with respect to the rotation momentums, and the square of the product of the horizontal shafts 16 to 18 from the centroid of the weight member 103, and is given by the following equation (6). FIG. 15 is a view showing the inertial momentum applied to the blade member. Here, the weight of the long part is represented by ω_{A1}, the weight of the short part is represented by ω_{A2}, and the weight of the load member 103 is represented by ωₓ.

Also, the length of the long part is represented by I₁, the length of the short part is represented by I₂, and the load member 103 of the horizontal shaft 16 to 18 is represented by Iₓ.

N=(ω_{A1}×(1/2×I₁)²)+(ω_{A2}×(1/2×I₂)²)+(ωₓ×(1/2×Iₓ)²) (6)

From the equation (5), ωₓ is defined as the following equation (7).

ωₓ=((I₁×ω_{A1})−(I₂×ω_{A2}))/(Iₓ) (7)

By substituting the equation (6) to the equation (7), the inertial momentum N is defined as the following equation (8).

N=(ω_{A1}×(1/2×I₁))+(ω_{A2}×(1/2×I₂)²)+(((I₁×ω_{A1})−(I₂×ω_{A2}))×(1/2)²×Iₓ) (8)

Denoting (ω_{A1}(1/2×I₁)²)+(ω_{A2}×(1/2×I₂)²) by coefficient b and ((I₁×ω_{A1})−(I₂×ω_{A2}))×(1/2)² by coefficient a, the inertial momentum given by the equation (8) is defined as equation (9).

N=a×I+b (9)

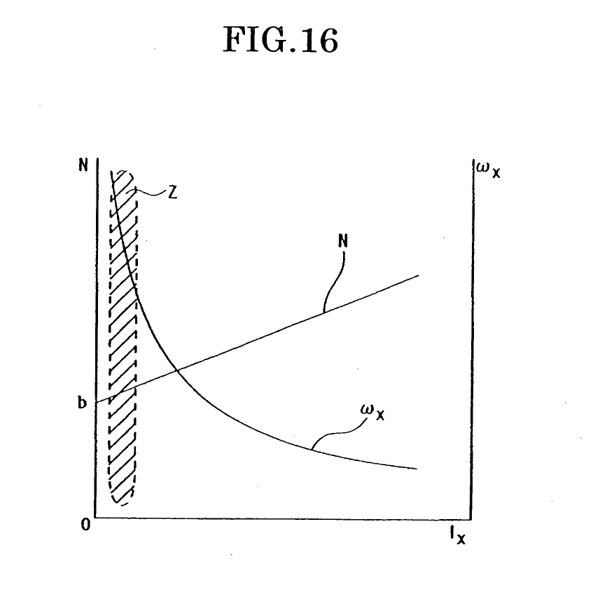

FIG. 16 is a graph showing the relationship between the equations (7) and (9). Specifically, FIG. 16 is a view showing the relation between the position of disposition of the load member and the inertial momentum. In FIG. 16, the curved plot shows the relation between the distance Iₓ and the weight ωₓ of the load member 103 as calculated by the equation (7), and the straight plot shows the relation between the distance Iₓ and the inertial momentum N as calculated by the equation (9).

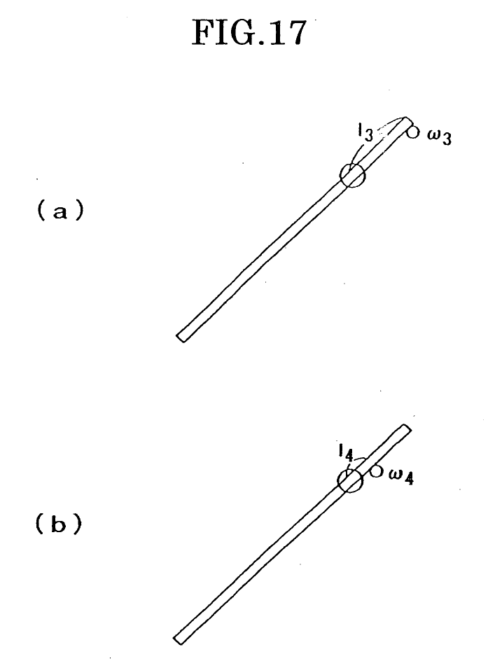

As shown by a zone Z in FIG. 16, the weight ωₓ of the load member 103 is increased with reducing distance Iₓ, and the inertial momentum N approximates the minimum value b with reducing distance. Thus, when adjusting the weight balance by taking out the weight balances with respect to the rotation momentum and the inertial momentum into considerations, the load member 103 is preferably disposed such as to make the distance Iₓ as small as possible. For example, the disposition relation shown in FIG. 17(b) is preferred to the disposition relation shown in FIG. 17(a). FIGS. 17(a) and 17(b) are views showing a way of weight balance adjustment. Specifically, FIG. 17(a) is a view showing a state, in which the load member 103 is disposed on the outer end side (i.e., the side remoter from the horizontal shafts 16 to 18) of the short part. FIG. 17(b) shows a state, in which the load member 103 is disposed on the inner end side (i.e., the side closer to the horizontal shafts 16 to 18) of the short part. In FIG. 17(a) the weight of the load member 103 is denoted by w₃, and the distance of the horizontal shafts 16 to 18 from the position, at which the load member 103 is disposed, is denoted by I₃. In FIG. 17(b), the weight of the load member 103 is denoted by ω₄, and the distance of the horizontal shafts 16 to 18 from the position of disposition of the load member 103 is denoted by I₄. In this case, the weights ω₃ and ω₄ are related as ω₃<<ω₄. Also, the distances I₃ and I₄ are related as I₃>I₄.

As shown above, for minimizing the wind energy consumed in the plane orientation change of the first and second blade members 19 to 24, it is preferable to make the rotation momentum M as low as possible. For reducing the rotation momentum M, the weight balances of the first and second blade members 19 to 24 are preferably adjusted such as to make the rotation momentum M computed by the equation (4) to be as low as possible (i.e., zero or a value close to zero). Specifically, by forming the first and second blade members 19 to 24 such that the difference between the rotation momentums on the first and second sections by the gravitational force is at most less than 0.2 times the higher one of the rotation momentums on the first and second sections generated by the gravitational forces, the first and second blade members 19 to 24 are smoothly rotated very smoothly without loss of wind energy and with slight winds.

Further, for minimizing the wind energy consumed in the plane orientation change of the first and second blade members, the inertial momentum N is preferably made as low as possible. For reducing the inertial momentum N, the weight balance of the first and second blade members 19 to 24 are preferably adjusted to make the distance Iₓ of the horizontal shafts 16 to 18 from the position of disposition of the horizontal shafts 16 to 18 as small as possible (i.e., to a value as close to zero as possible). Ideally, the position of load application is set to be within 0.1 times the width of the load application side member (i.e., short part) from the horizontal shafts 19 to 24. By so doing, the first and second blade members 19 to 24 are desirously rotated very smoothly without wind energy loss and with slight winds.

After the weight balances with respect to the rotation momentum and the inertial momentum, the first and second blade members 19 to 24 are rotated in a predetermined direction about the horizontal shafts 16 to 18, and they are rotated about the horizontal shaft 16 to 18 more smoothly without substantially consuming the wind energy and with slight winds. Thus, the rotation efficiency of the vertical shaft 12 is extremely improved.

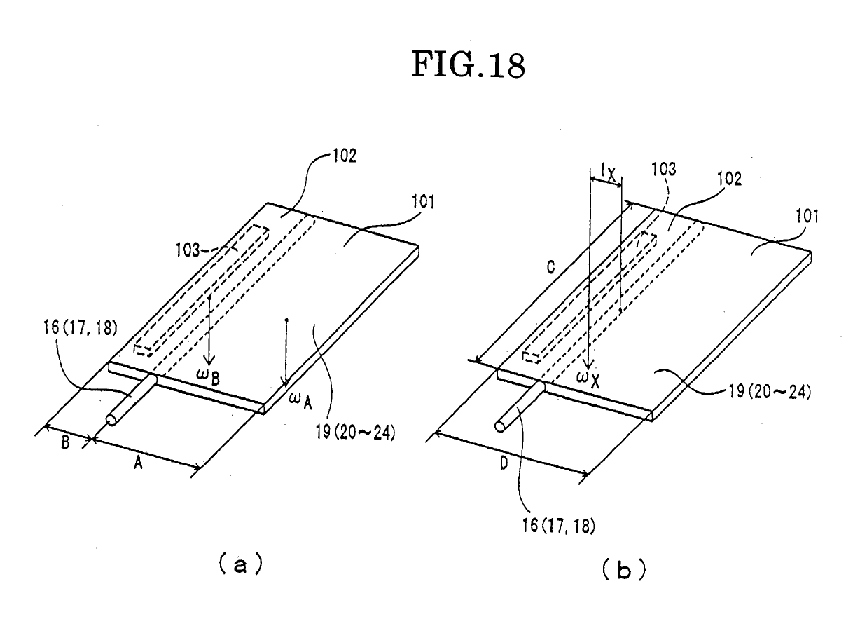

FIGS. 18(a) and 18(b) show the arrangement of the first and second blade members 19 to 2.4 used in experiments. Specifically, FIG. 18(a) shows the relation between the lengths of the first and second sections, and FIG. 18(b) shows the relation between the length and width of the blade member. In FIGS. 18(a) and 18(b), the horizontal shafts 16 to 18 are shown by dashed lines just like they were present in the center of the first and second blade members 19 to 24. However, the dashed lines are virtual lines for describing the first and second sections centered in the horizontal shaft 16 to 18. Actually, the horizontal shafts 17 to 18 are mounted on end parts of the first and second blade members 19 to 24, and hence they are not present inside the first and second blade members 19 to 24.

In the FIG. 18(a) Example, the blade members 19 to 24 are formed such that the dimension A of the large area part 101 is larger than the dimension B of the small area part 102 (i.e., the other blade member), i.e., A>>B.

In the blade members 19 to 24, the large and small area parts 101 and 102 receive wind power of different magnitudes. It is experimentally proved that the ratio B/A is suitably about 10 to 1.5.

The efficiency of the blade members 19 to 24 is variable depending on the length and width. It is experimentally proved that the length C shown in FIG. 18(b) is suitably several ten to several hundred centimeters and that the ratio of the length C to the width D is about 5:1 to 2:1.

Preferably, at the time of no load and no wind, the first and second blade members 19 to 24 remain stationary with their plane orientation of a downward angle of 45 degrees from horizontal plane. Accordingly, the rotation momentums M of the long and short parts are preferably made to be slightly different from each other. Specifically, the rotation momentums M₁ and M₂ of the first and second blade members 19 to 24 about the horizontal shafts 17 to 18 are preferably M₁>M₂.

At its experimentally proved that the ratio of the difference between the rotation momentums M_{1 and M}₂ (i.e., M₁-M₂) to the higher rotation momentums M₁ is as shown in Tables 1 to 3 below. The experiments shown in Tables 1 to 3 were conducted by using blade members with width of 320 mm and weight of 1,700 g and with three different dimension sets of the short and long parts. In Experiment 1, the long part dimension was set to 240 mm, and the short part dimension was set to 80 mm. In Experiment 2, the long part dimension was set to 200 mm, and the short part dimension was set to 120 mm. In Experiment 3, the long part dimension was set to 170 mm, and the short part dimension was set to 150 mm. In these three experiments, the distance of the horizontal shafts 16 to 18 from the position of disposition of the load member 103 is represented by Iₓ, the weight of the load member 103 was represented by ωₓ, and the ratio of the difference between the rotation momentums M₁ and M₂ (i.e., M₁-M₂) to the higher rotation momentum M₁ was represented by Ratio. In these three experiments, satisfactory results could be obtained with Ratio of 0.2 times or below.

| | | | |
|---|---|---|---|
| Iₓ (mm) | ωₓ (g) | Ratio | Result |

EXPERIMENT 1

| | |
|---|---|
| Width of blade member 320 (mm) | Weight of blade member 1700 (g) |
| A 240 (mm) | B 80 (mm) |

| | | | |
|---|---|---|---|
| 80 | 1000 | 0.37 | Impossible |
| 80 | 1200 | 0.26 | Impossible |
| 80 | 1300 | 0.21 | Impossible |
| 80 | 1400 | 0.16 | Good |
| 80 | 1600 | 0.05 | Good |
| 60 | 1500 | 0.30 | Impossible |
| 60 | 1600 | 0.26 | Impossible |
| 60 | 1700 | 0.22 | Impossible |
| 60 | 1800 | 0.18 | Good |
| 60 | 2000 | 0.10 | Good |
| 60 | 2200 | 0.03 | Good |
| 40 | 2400 | 0.26 | Impossible |
| 40 | 2500 | 0.24 | Impossible |
| 40 | 2600 | 0.21 | Impossible |
| 40 | 2700 | 0.18 | Good |
| 40 | 2900 | 0.13 | Good |
| 40 | 3100 | 0.08 | Good |

EXPERIMENT 2

| | |
|---|---|
| Width of blade member 320 (mm) | Weight of blade member 1700 (g) |
| A 200 (mm) | B 120(mm) |

| | | | |
|---|---|---|---|
| 120 | 300 | 0.30 | Impossible |
| 120 | 350 | 0.24 | Impossible |
| 120 | 400 | 0.19 | Impossible |
| 120 | 500 | 0.08 | Good |
| 120 | 550 | 0.02 | Good |
| 60 | 300 | 0.47 | Impossible |
| 60 | 500 | 0.36 | Impossible |
| 60 | 700 | 0.24 | Impossible |
| 60 | 900 | 0.13 | Good |
| 60 | 1100 | 0.02 | Good |
| 30 | 1200 | 0.30 | Impossible |
| 30 | 1400 | 0.24 | Impossible |
| 30 | 1500 | 0.22 | Impossible |
| 30 | 1600 | 0.19 | Good |
| 30 | 1900 | 0.10 | Good |
| 30 | 2100 | 0.05 | Good |
| 30 | 2200 | 0.02 | Good |

EXPERIMENT 3

| | |
|---|---|
| Width of blade member 320 (mm) | Weight of blade member 1700 (g) |
| A 170 (mm) | B 150 (mm) |

| | | | |
|---|---|---|---|
| 150 | 10 | 0.20 | Impossible |
| 150 | 30 | 0.16 | Good |
| 150 | 70 | 0.08 | Good |
| 150 | 110 | 0.01 | Good |
| 60 | 10 | 0.21 | Impossible |
| 60 | 50 | 0.18 | Good |
| 60 | 130 | 0.12 | Good |
| 60 | 170 | 0.09 | Good |
| 30 | 10 | 0.22 | Impossible |
| 30 | 90 | 0.19 | Good |
| 30 | 270 | 0.12 | Good |
| 30 | 390 | 0.07 | Good |
| 30 | 510 | 0.02 | Good |

With the first and second blade members 19 to 24 as shown above, the large area part 101 is heavier than the small area part 102, and the blade members 19 to 24 thus operate such that the large area part 101 is below the small area part 102. It is thus possible to provide stable operation of the first and second blade member 19 to 24.

Such weight balance adjustment of the first and second blade members 19 to 24, permits these blade members 19 to 24 to be rotated quickly about the horizontal shafts 16 to 18 about the horizontal shafts 16 to 18 even when the wind power is slight. The adjustment is thus particularly effective in the case when the received wind is slight with a wind velocity of 3.4 m/sec. or below and called “wind power 2”.

(Modifications)

The above embodiment of the present invention is by no means limitative, and various changes and modifications and applications are conceivable without departing from the scope of the present invention. Some modifications will be described hereinunder.

(First Modification)

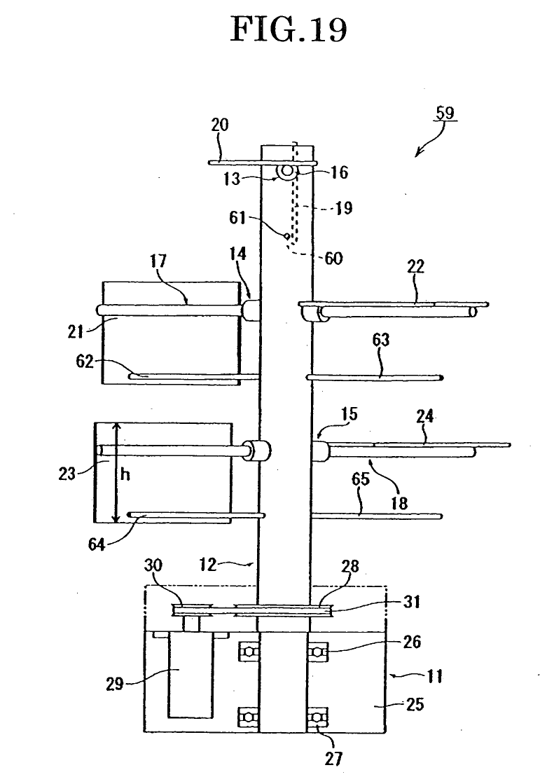

FIG. 19 is a view showing a first modification of the drive power apparatus utilizing winds. In the above embodiment of the drive power apparatus 110 utilizing winds, the horizontal shafts 16 to 18 were provided with the rotation restricting mechanisms for stopping the first and second blade members 19 to 24 at a predetermined angle. In the first modification of drive power apparatus 59 utilizing winds, the vertical shaft 12 has angle restricting mechanisms provided as stoppers for supporting the back of the blade members 19 to 24 in the vertically directed state thereof.

Specifically, in the drive power apparatus 59, stopper bars 50 to 65 as an example of stopper are provided such that their stem parts are secured to the vertical shaft 12 at positions right underneath the horizontal shafts 16 to 18, respectively, and at a distance therefrom within the height h of the blade members 19 to 24. The stopper bars 60 to 65 receive an intermediate or outer end part of the blade members 19 to 24, and thus the blade members 19 to 24 are supported in an opposite end support form or a nearly this form. Thus, in the first modification, it is possible to reduce the mechanical strength of the parts of the blade members 19 to 24. In other words, it is possible to reduce the weight of the blade members 19 to 24.

(Second Embodiment)

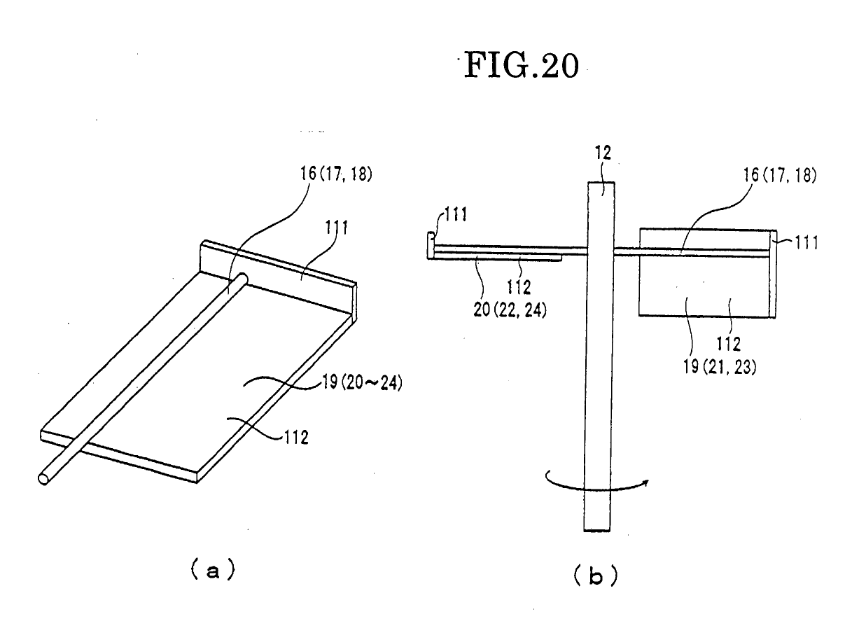

FIGS. 20(a) and 20(b) are views showing a second modification of the drive power apparatus utilizing winds. Specifically, FIG. 20(a) is a perspective view showing the first and second blade members 19 to 24 taken in an oblique direction, and FIG. 20(b) is a side view showing the first to second blade members 19 to 24. In the second modification, the outer end of the first and second blade members 19 to 24 have an auxiliary wing 111 crossing the horizontal shafts 16 to 18 at right angles. The auxiliary wing 111 has a size of several to several ten centimeters. The auxiliary wing 111 acts to suppress wind W tending to get out the first and second blade members 19 to 24 from the outer end thereof. Thus, in the second modification, the power of wind w applied to the first and second blade members 19 to 24 can be improved by about several to several ten percent to improve the efficiency of conversion of the energy of wind W to drive power. Hereinafter, the part of the first and second blade members 19 to 24 that is parallel to the horizontal shafts 16 to 18, is referred to as main wing 11 for discriminating it from the auxiliary wing 111.

(Third Modification)

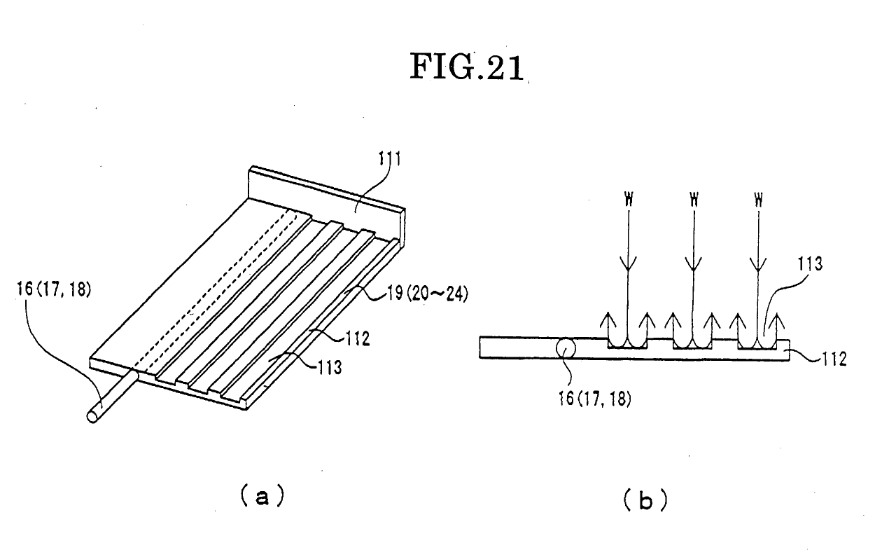

FIGS. 21(a) and 21(b) are views showing a third modification of the drive power apparatus utilizing winds. Specifically, FIG. 21(a) is a perspective view showing the first and second blade members 19 to 24 taken in an oblique direction, and FIG. 21(b) is a side view showing the first and second blade members 19 to 24. In the third embodiment, the main wing of the first and second blade members 19 to 24 has grooves 113 of several to several ten millimeters extending parallel to the horizontal shafts 16 to 18. The grooves 113 act to seal wind W. With this apparatus, the power of wind W applied to the first and second blade members can be improved by several to several ten percent to improve the efficiency of conversion of the energy of wind W to drive power. FIGS. 21(a) and 21(b) show an arrangement, in which the horizontal shafts 16 to 18 penetrate the first and second blade members 19 to 24.

(Fourth Modification)

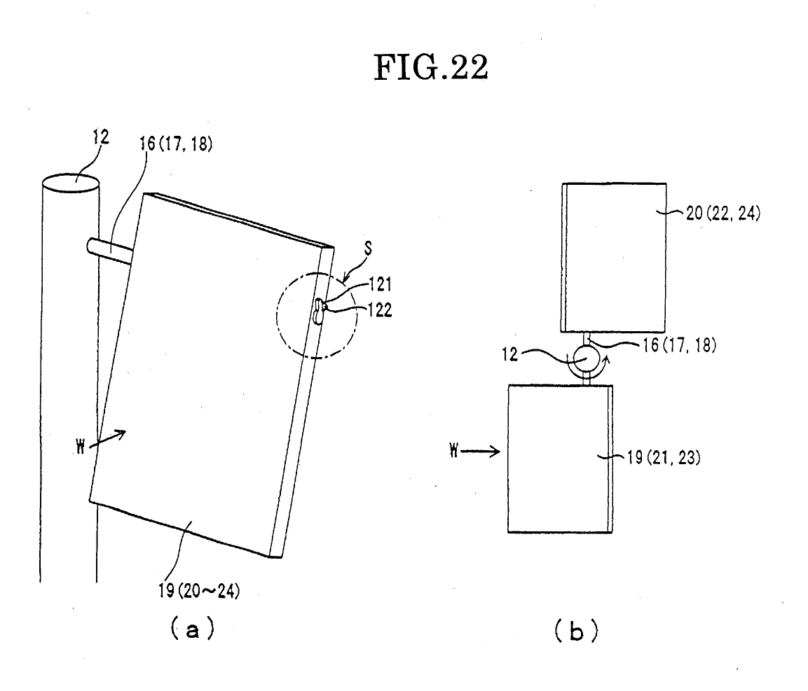

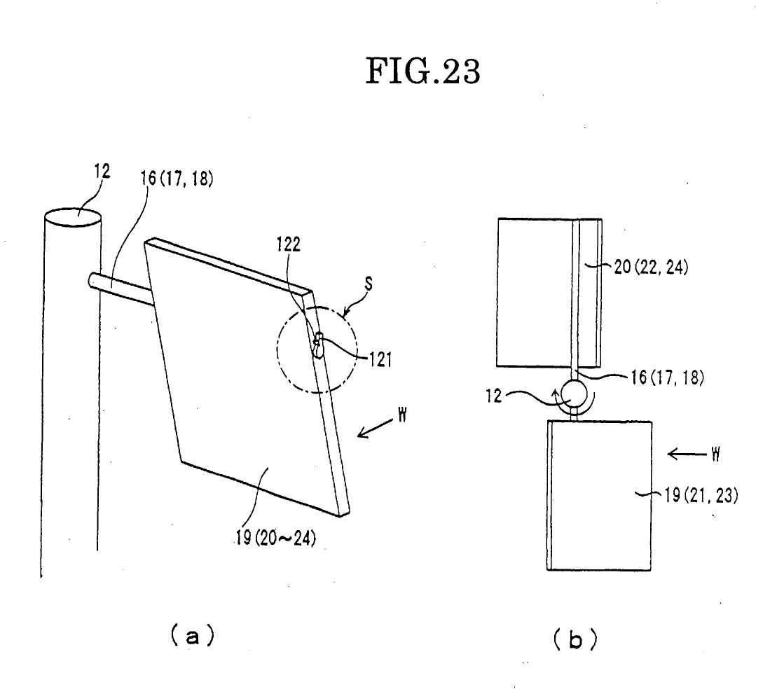

FIGS. 22(a) and 22(b) and FIGS. 23(a) and 23(b) are views showing a fourth embodiment of the drive power apparatus utilizing winds. Specifically, FIGS. 22(a) and 23(a) are perspective views showing the first and second blade members 19 to 24 taken in an oblique direction, and FIGS. 22(b) and 23(b) are top views showing the first and second blade members 19 to 24. In the vertical shaft 12, a rotation setting mechanism permitting the setting of the rotational direction, as desired, of the vertical shaft 12.

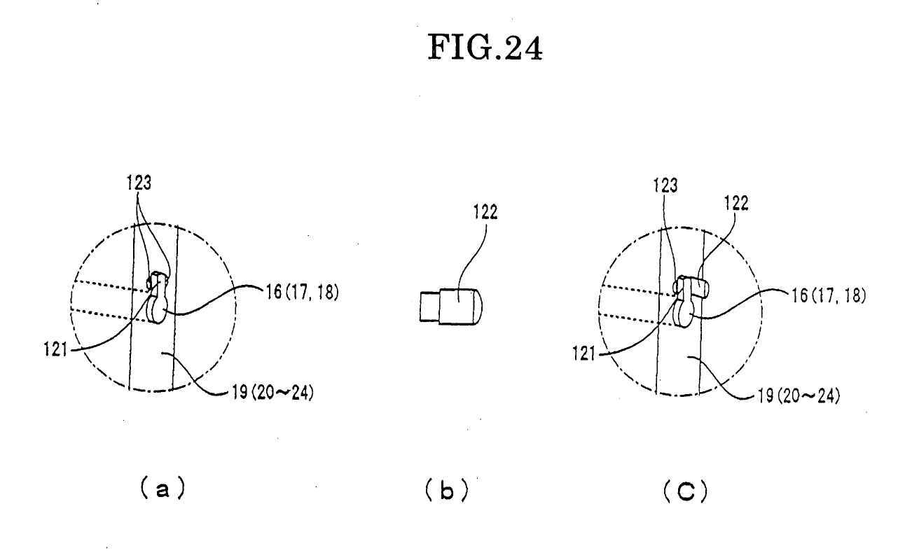

FIGS. 24(a) to 24(c) show a specific arrangement of the rotation setting mechanism. FIGS. 24(a) to 24(c) are enlarged views showing part S in FIGS. 22(a) and 22(b) and 23(a) and 23(b). FIG. 24(a) shows the arrangement around the horizontal shafts 16 to 18, FIG. 24(b) shows the arrangement of a lock pin 122, and FIG. 24(c) shows a state, in which the pin 122 is secured to a hole 123 in the horizontal shafts 16 to 18.

As shown in FIGS. 24(a) to 24(c), the rotation setting mechanism includes a protuberance 121 provided on the horizontal shafts 16 to 18, a pin 122 to be engaged with the protuberance 121, and holes 123 formed in the first and second blade members 19 to 24 around the horizontal shafts 17 to 18. The holes 123 are formed on the opposite sides of the protuberance 121, and the pin 122 is inserted in either one of the left and right holes 123 in dependence on the direction of rotation of the vertical shaft 12. For example, when the pin 122 is inserted in the right side hole 123, it supports the first and second blade members 19 to 24 in its state as shown in FIGS. 22(a) and 22(b). Thus, the vertical shaft 12 is rotated counterclockwise. When the pin 122 is inserted in the left side hole 123, it supports the first and second blade members 19 to 24 in the state as shown in FIGS. 23(a) and 23(b). Thus, the vertical shaft 12 is rotated clockwise. As shown, in the fourth embodiment it is possible to set the direction of rotation of the vertical shaft 12 as desired.

The rotation setting mechanism of the arrangement as shown in FIGS. 22 to 24 are by no means limitative. For example, it is possible to provide a protuberance like the protuberance on the vertical shaft 12 at a position close to the base 11, provide holes equal in number to the number of the holes 123 in the pulley 28 and inset a pin like the pin 122 in either of the holes.

(Fifth Modification)

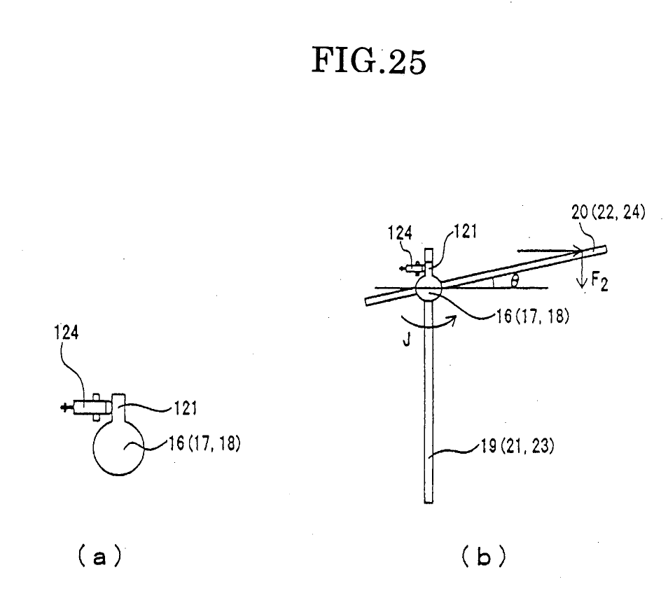

FIGS. 25(a) and 25(b) are views showing a fifth modification of the drive power apparatus utilizing winds. Specifically, FIG. 25(a) shows the arrangement around the horizontal shafts 16 to 18, and FIG. 25(b) shows the secured state of the first and second blade members 19 to 24.

In the fifth modification, the horizontal shafts 16 to 18 and the first and second blade members 19 to 24 are rotatably coupled to one another. In this case, the horizontal shafts 16 to 18 are provided with a protuberance 121, the first and second blade members 19 to 24 are provided with a shock absorber (i.e., oil hydraulic bumper) 124, and the protuberance 121 and the oil hydraulic bumper 124 are to be engaged with each other.

By the engagement of the protuberance 121 and the oil hydraulic bumper 124 with each other, the first and second blade members 19 to 24 are secured to the horizontal shafts 16 to 18. It is now assumed that the first and second blade members 19 to 24 are rotated in, for instance, direction J. At this time, the protuberance 121 is brought into contact with the oil hydraulic bumper 124. The position of contact of the protuberance 121 can be set by adjusting the extent of projection of the oil hydraulic bumper 124. The position of contact of the protuberance 12 is preferably set by taking the weight F2 of first blade members 19, 21 and 23 having been raised in the horizontal direction or the second blade members 20, 22 and 24 into considerations. In the FIG. 25(b) example, it is assumed that the first blade members 19, 21 and 23 having been raised in the horizontal direction or the blade members 20, 22 and 24 sink to an extent corresponding to angle θ. Accordingly, the oil hydraulic bumper 124 is projected to an extent that the plane orientation of the first blade members 19, 21 and 23 or the second blade members 20, 22 and 24 is at the angle θ, thus alleviating the shock that would be otherwise produced by the sinking of the first blade members 19, 21 and 13 having been raised in the horizontal direction or the second blade member 20, 22 and 24 to the extent corresponding to the angle.

As shown above, in the fifth modification, it is possible to have the first and second blade members 19 to 24 fixed with a desired plane orientation. Also, it is possible to alleviate shocks exerted to the first and second blade members 19 to 24, the horizontal shafts 16 to 18 and the vertical shaft 12, prevent wear of these members extend the life of the whole apparatus.

The shock absorber may also be provided on either the side of the first and second contact members 46 and 47 or the side of the first and second contactable members 48 and 49. In this case, it is particularly possible to prevent wear of the first and second contact members 46 and 47 and the first and second contactable members 48 and 49.

(Sixth Modification)

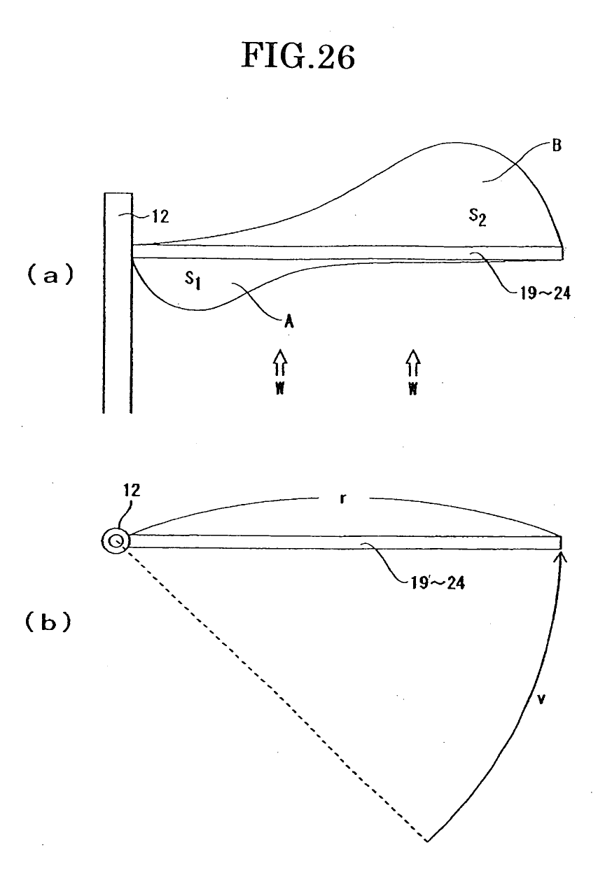

FIGS. 26(a) and 26(b) show a sixth modification. As shown, the first and second blade members 19 to 24 can be formed to have desired sizes and also desired shapes. In this case, the first and second blade members 19 to 24 may receive wind power of different magnitudes although their areas are the same.

For example, in the arrangement as shown in FIGS. 26(a) and 26(b), the wind power F received by an inner end side part (i.e., side closer to the vertical shaft 12) A is as given by the following equation (10), and the wind power F received by an outer end side part (i.e., side remoter from the vertical shaft 12) B is as given by the following equation (11). Here, the wind velocity is represented by V, the peripheral speed of the inner end side part A of the first and second blade members 19 to 24 is represented by v_{A}, the peripheral speed of the outer end side part B of the first and second blade members 19 to 24 is represented by v_{B}, the area of the inner end side part A of the first and second blade members 19 to 24 is represented by S₁, the area of the outer end side part of the first and second blade members 19 to 24 is represented by S₂, and the length of the first and second blade members 19 to 24 is represented by r. Symbol ∞ represents the proportional relation.

F∞(V−v_{A})×S₁ (10)

F∞(V−v_{B})×S₂ (11)

In this case, the wind velocity V and the peripheral speed v are related to each other as v=V×r.

With the relations of these equations, when the areas S₁ and S₂ of the inner and outer end side parts A and B of the first and second blade members 19 to 24 are the same, the inner end side part A receives higher power from wind compared to the outer end side part B. Thus, the first and second blade members 19 to 24 can be formed to desired shapes such that the inner and outer end side parts A and B receives power of different magnitudes from wind even with the areas S₁ and S₂ of these parts A and B are the same.

According to the present invention, various modifications other than those described above may be made without departing from the scope of the present invention. For example, while in the above example the blade members had a rectangular shape, other shapes such as semi-circular and triangular shapes are also covered in the scope of the present invention.

While in the above embodiment the rotation drive power was utilized as electric power, the present invention is also applicable to pumps, water wheels, and so forth.

Furthermore, while in the above embodiment bushes were used in the rotary parts of the horizontal shafts 16 to 18, it is preferable to use bearings.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A drive power apparatus utilizing winds comprising:
a vertical shaft disposed vertically and rotatably;
a rotatable horizontal shaft rotatably perpendicularly penetrating the vertical shaft;
a first and a second plate-like blade member provided on the horizontal shaft on the opposite sides of the vertical shaft; and
a drive power mechanism operable with the rotation of the vertical shaft;
wherein the first and second blade members are secured to the horizontal shaft such that their plane orientations are deviated from each other by an angle of 90 degrees in the peripheral direction of the horizontal shaft, and are rocked about the horizontal shaft in an interlocked relation to each other between the vertical and horizontal directions.

2. The drive power apparatus utilizing winds according to claim 1, wherein:
denoting two parts of each of the first and second sections as defined by the horizontal shaft to be a first and a second section, respectively, the first and second sections are formed such as to receive wind power of different magnitudes and provided by a weight balance adjustment of providing a load on the side of the lower one of the rotation momentums generated on the first and second sections by gravitational forces.

3. The drive power apparatus utilizing winds according to claim 2, wherein:
the first and second blade members are formed by the weight balance adjustment such that the difference between the rotation momentums generated on the first and second sections by gravitational forces is at most no higher than 0.2 times the higher one of the rotation momentums generated on the first and second sections by gravitational forces.

4. The drive power apparatus utilizing winds according to one of claims 1 to 3, wherein:
a plurality of horizontal shafts are disposed as respective stages on the vertical shaft at vertically different positions thereof and in a predetermined angular interval deviation from one another in the peripheral direction of the vertical shaft.

5. The drive power apparatus utilizing winds according to claim 4, wherein:
the predetermined angle is obtained by dividing 180 degrees by the number of stages or a multiple of that angle.

6. The drive power apparatus utilizing winds according to claim 5, wherein:
the horizontal shafts constituting the respective stages are disposed helically.

7. The drive power apparatus utilizing winds according to one of claims 1 to 6, which further comprises a restricting mechanism for restricting the rotation of each horizontal shaft to a range of 90 degrees, and in which:
the restricting mechanism includes a first and a second contact member provided on the horizontal shaft on the opposite sides of the vertical shaft, and a first and a second contactable member provided on the vertical shaft and capable of being contacted by the first and second contact members.

8. The drive power apparatus utilizing winds according to one of claims 1 to 7, wherein:
the first and second blade members are provided with shock absorbers.

9. The drive power apparatus utilizing winds according to one of claims 1 to 8, which further comprises:
stoppers projecting from the vertical shaft for stopping the rotation of the first and second blade members in contact with the first and second blade members.

10. The drive power apparatus utilizing winds according to one of claims 1 to 9, wherein:
vertical shaft has bearings for alleviating frictional resistance with respect to each horizontal shaft.

11. The drive power apparatus according to one of claims 1 to 10, which further comprises:
a rotation setting mechanism for setting the direction of rotation of the vertical shaft.

12. The drive power apparatus utilizing winds according to one of claim 11, wherein the rotation setting mechanism includes:
a protuberance provided on each horizontal shaft; and
an engagement member for determining the direction of rotation of the vertical shaft in engagement with the protuberance.

13. The drive power apparatus utilizing winds according to one of claims 1 to 12, which further comprises:
oil hydraulic bumpers provided on each horizontal shaft for setting the plate orientations of the first and second blade members.

14. A plate-like blade member used in the drive power apparatus utilizing winds according to claim 1, wherein:
denoting the two parts defined by the horizontal shaft to be a first and a second section, the first and second sections are formed such as to receive wind power of different magnitudes and are formed by providing a weight balance adjustment of providing a load on the side of the lower one of the rotation momentums generated on the first and second sections by gravitational forces.

15. The blade member according to claim 14, wherein:
the weight balance adjustment is made such that the difference between the rotation momentums generated on the first and second sections by gravitational forces is at most no higher than 0.2 times the higher one of the rotation momentums generated on the first and second sections by gravitational forces.

16. The blade member according to claim 15, wherein:
the rotation momentum difference is set by making the weights per unit area of the first and second sections different.

17 The blade member according to claim 16, wherein:
the weights per unit area of the first and second sections are made different by providing a load to either one of the first and second sections.

18. The blade member according to claim 16, wherein:
the weights per unit area of the first and second sections are made different by forming the first and second sections from materials of different specific gravities.

19. The blade member according to claim 16, wherein:
the weights per unit area of the first and second sections are made different by setting different thicknesses of the first and second sections.

20. The blade member according to claim 14, wherein:
for reducing the inertial momentum which is increased at the time of the weight balance adjustment, the position of the load disposed in the weight balance adjustment is set to be within 0.1 times the width of the load provision side member from each horizontal shaft.

21. The blade member according to one of claims 14 to 20, which has an auxiliary wing extending in a direction perpendicular to each horizontal shaft.

22. The blade member according to one of claims 1 to 20, which has grooves formed in its surface.

23. A rotating member utilizing winds comprising:
a vertical shaft disposed vertically and rotatably;
a rotatable horizontal shaft rotatably perpendicularly penetrating the vertical shaft; and
a first and a second plate-like blade member provided on the horizontal shaft on the opposite sides of the vertical shaft;
wherein the first and second blade members are secured to the horizontal shaft such that their plane orientations are deviated from each other by an angle of 90 degrees in the peripheral direction of the horizontal shaft, and are rocked about the horizontal shaft in an interlocked relation to each other between the vertical and horizontal directions.

24. The rotating member utilizing winds according to claim 23, wherein:
denoting two parts of each of the first and second sections as defined by the horizontal shaft to be a first and a second section, respectively, the first and second sections are formed such as to receive wind power of different magnitudes and provided by a weight balance adjustment of providing a load on the side of the lower one of the rotation momentums generated on the first and second sections by gravitational forces.

25. The rotating member utilizing winds according to claim 24, wherein:
the first and second blade members are formed by the weight balance adjustment such that the difference between the rotation momentums generated on the first and second sections by gravitational forces is at most no higher than 0.2 times the higher one of the rotation momentums generated on the first and second sections by gravitational forces.

26. The rotating member utilizing winds according to one of claims 23 to 25, wherein:
a plurality of horizontal shafts are disposed as respective stages on the vertical shaft at vertically different positions thereof and in a predetermined angular interval deviation from one another in the peripheral direction of the vertical shaft.

27. The rotating member utilizing winds according to claim 26, wherein:
the predetermined angle is obtained by dividing 180 degrees by the number of stages or a multiple of that angle.

28. The rotating member utilizing winds according to claim 27, wherein:
the horizontal shafts constituting the respective stages are disposed helically.

29. The rotating member utilizing winds according to one of claims 23 to 28, which further comprises a restricting mechanism for restricting the rotation of each horizontal shaft to a range of 90 degrees, and in which:
the restricting mechanism includes a first and a second contact member provided on the horizontal shaft on the opposite sides of the vertical shaft, and a first and a second contactable member provided on the vertical shaft and capable of being contacted by the first and second contact members.

30. The rotating member utilizing winds according to one of claims 23 to 29, wherein:
the first and second blade members are provided with shock absorbers.

31. The rotating member utilizing winds according to one of claims 23 to 30, which further comprises:
stoppers projecting from the vertical shaft for stopping the rotation of the first and second blade members in contact with the first and second blade members.

32. The rotating member utilizing winds according to one of claims 23 to 31, wherein:
vertical shaft has bearings for alleviating frictional resistance with respect to each horizontal shaft.

33. The rotating member utilizing winds according to one of claims 23 to 32, which further comprises:
a rotation setting mechanism for setting the direction of rotation of the vertical shaft.

34. The rotating member utilizing winds according to claim 33, wherein the rotation setting mechanism includes:
a protuberance provided on each horizontal shaft; and
an engagement member for determining the direction of rotation of the vertical shaft in engagement with the protuberance.

35. The rotating member utilizing winds according to one of claims 23 to 24, which further comprises:
oil hydraulic bumpers provided on each horizontal shaft for setting the plate orientations of the first and second blade members.
